(19) United States
(12) Patent Application Publication
(10) Pub. No.: US 2025/0246178 A1
(43) Pub. Date: Jul. 31, 2025

(54) ADAPTIVE SPEECH ELABORATION AND FEEDBACK FOR SPEECH THERAPY

(71) Applicant: UNIVERSITY OF SOUTH FLORIDA, Tampa, FL (US)

(72) Inventor: Gerald Imaezue, Tampa, FL (US)

(21) Appl. No.: 19/043,393

(22) Filed: Jan. 31, 2025

Related U.S. Application Data
(63) Continuation-in-part of application No. 19/043,386, filed on Jan. 31, 2025.
(60) Provisional application No. 63/627,136, filed on Jan. 31, 2024.
(60) Provisional application No. 63/752,487, filed on Jan. 31, 2025.

(51) Int. Cl. G10L 15/01; G10L 15/22

(52) U.S. Cl. CPC G10L 15/01; G10L 15/22

(57) ABSTRACT

A method may include receiving a speech response of a subject to a prompt; comparing the speech response to a previous speech response of the subject; determining a complexity for a subsequent prompt based on the comparison; applying a language model to the speech response to generate a corrected speech response; generating the subsequent prompt based on the determined complexity and the corrected speech response; and providing the subsequent prompt to the subject to receive a subsequent speech response.

### CROSS-REFERENCE TO RELATED APPLICATIONS

This application claims priority to U.S. Provisional Application No. 63/627,136, filed on Jan. 31, 2024, and claims priority to U.S. Provisional Application No. 63/752,487, filed on Jan. 31, 2025, the entire content of which are hereby incorporated by reference in their entirety. This application is a continuation-in-part of prior U.S. application Ser. No. 19/043,386, filed Jan. 31, 2025, the entire content of which is hereby incorporated by reference in its entirety.

### BACKGROUND

Speech and language impairments, such as aphasia, can arise from neurological conditions including stroke, traumatic brain injuries, or degenerative diseases. Aphasia is a condition that affects a person's ability to produce and comprehend language, leading to significant challenges in communication. Individuals with aphasia often experience difficulty forming words, constructing sentences, and maintaining fluency in spontaneous speech. These challenges can severely impact personal, social, and professional interactions, reducing the individual's overall quality of life.

Traditional speech therapy for aphasia and related speech impairments typically involves structured exercises conducted under the guidance of a speech-language pathologist. These interventions often rely on modeling and/or external feedback to reinforce correct speech patterns. For example, typical “modeling” approaches can involve a speech-language pathologist providing an example of correct speech production, which the patient then is expected to imitate or repeat. The pathologist listens to the response, manually assesses accuracy of the repeated speech in real time, and provides feedback to the patient accordingly during the appointment.

However, such methods may require frequent clinical visits, access to specialized providers, and ongoing external reinforcement, making them less accessible to individuals with logistical, financial, or geographic barriers to care as well as less helpful in terms of effectuating speech improvement. For example, existing therapy models do not emphasize real-time self-monitoring from the patient (because the patient is accustomed to, and in a position to, rely on the pathologist for monitoring and correction) and do not allow for ongoing training and iterative speech improvement outside of the clinic, which the inventor has established are critical components of effective language rehabilitation.

Therefore, a need exists for improved systems and methods that enable individuals with speech impairments to engage in effective, independent, regular, and adaptive speech therapy without relying solely on external reinforcement. There is further a need for speech therapy systems that leverage technological advancements to provide structured, data-driven, and dynamically adjustable feedback tailored to the user's evolving speech patterns that can be available on-demand and at regular intervals outside of a clinical setting.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any of all aspects of the disclosure. Its purpose is to present some concepts of one or more aspects of the disclosure in a simplified form as a prelude to the more detailed description that is presented later.

Aspects of the described technology may include a method. For example, the method may include receiving a speech response of a subject to a prompt; comparing the speech response to a previous speech response of the subject; determining a complexity for a subsequent prompt based on the comparison; applying a language model to the speech response to generate a corrected speech response; generating the subsequent prompt based on the determined complexity and the corrected speech response; and providing the subsequent prompt to the subject to receive a subsequent speech response. Further aspects may include a non-transitory computer readable medium storing instructions to perform the method and a system in which the method may be performed.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 illustrate an example process of autonomous speech elaboration including feedback.

FIGS. 2A-2B illustrate an example process of autonomous speech elaboration including multi-modal recursive self-feedback.

FIGS. 3A-2B illustrate an example process of autonomous speech elaboration including personalized voice feedback.

FIG. 4 illustrates an example process for prompt complexity determination.

FIG. 5 is a flowchart illustration concepts of example processes according to some embodiments.

FIG. 6 is a block diagram conceptually illustrating hardware components, attributes, and connections of systems and devices according to some embodiments.

FIGS. 7A and 7B are a pair of flowcharts indicating protocols used in a study performed by the inventors.

FIGS. 7C and 7D are a pair of conceptual illustrations comparing user interfaces employed in studies performed by the inventors.

FIG. 7E is a diagram conceptually depicting a sequence of prompts, responses, and feedback according to some embodiments.

FIG. 8 is a graph of speech signal corresponding to a user response and associated assessments made in association with a study conducted by the inventors.

FIG. 9 is a set of graphs of results of a study conducted by the inventors.

FIG. 10 is a set of graphs of results of a study conducted by the inventors.

FIG. 11 is a set of graphs of results of a study conducted by the inventors.

FIG. 12 is a set of graphs of results of a study conducted by the inventors.

FIG. 13 is a chart of results of a study conducted by the inventors.

FIG. 14 is a chart of results of a study conducted by the inventors.

FIG. 15 is a chart of results of a study conducted by the inventors.

FIG. 16 is a chart of results of a study conducted by the inventors.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

This Detailed Description will include several sections that discuss aspects of the disclosure from various levels of detail and various perspectives. In particular, these sections will include: discussion of approaches, frameworks and associated general concepts that may be applicable to some or all of the more specific implementations contemplated herein; a discussion of the inventor' experiments and examples/prototypes used for validation; and descriptions of various embodiments or ways of implementing the systems and methods described herein. Thus, the descriptions of specific embodiments/implementations/examples should be understood to be capable of incorporating the more general frameworks and concepts as well as features of other specific embodiments, and vice versa.

Thus, the present disclosure also contemplates taking the general improvements, algorithms, and advantages described herein and deploying them into practical implementations and systems, so as to leverage the improvements and algorithms for specific applications and real-world situations.

### Example Processes for Providing Speech Therapy and Other Speech Assistance

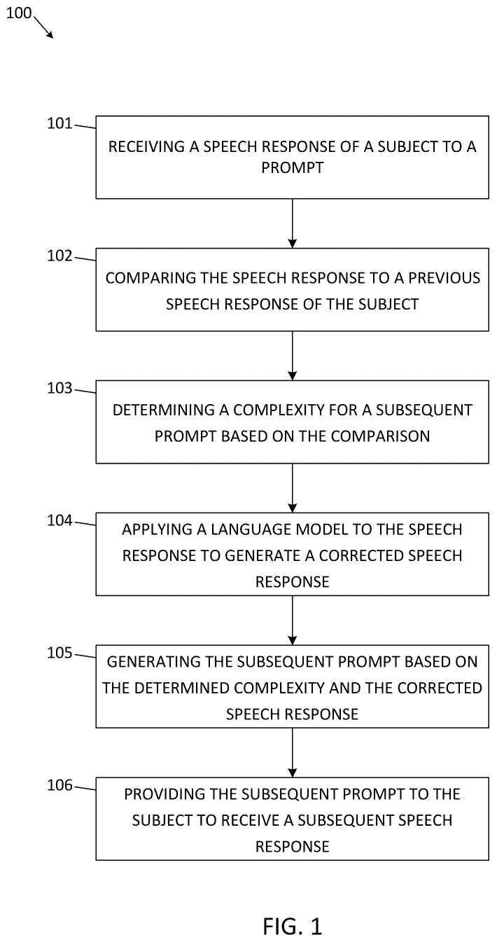

FIG. 1 illustrates an example process 100 of providing autonomous speech elaboration. For example, the illustrated method may be performed by a user device executing a speech elaboration application, a system comprising a user device and a server system. For example, the illustrated method may be performed via interaction with a server-hosted process by an application executed by a user device or via a web-application on a user device. The process may be implemented by a computing system that includes one or more servers, mobile applications, cloud-based processing resources, and data storage systems. In some embodiments, portions of the process may be executed on a patient's mobile device, while other portions may be executed on remote computing infrastructure managed by a therapy service provider or EMR.

The process 100 may include block 101, which may include receiving a speech response of a subject to a prompt. For example, block 101 may include receiving a speech response from a subject during a speech therapy session, such as an aphasia patient (e.g., nonfluent aphasia). As another example, block 101 may include receiving a speech response from a previous speech therapy.

Various prompts may be provided in different implementations. For instance, prompts may be associated with various stimuli/subjects, such as a favorite food, favorite pastime, holiday traditions, first job, morning routine, favorite television show or move, first car or bike, a school subject, general knowledge, etc. Prompts may include questions, pictures, videos, etc. Questions may be provided as visual text (e.g., readable text on a screen), auditory text (e.g., prior recorded prompts, spoken via a speech generation model, such as a text-to-speech model), or any suitable modality. In some cases, block 101 may include receiving a selection from the subject regarding the prompt, such as how the prompt will be delivered, the subject of the prompt, etc.

In some cases, prompts may be segmented by complexity level (e.g., normal speech, mild aphasia, moderate cases, moderate-severe cases, severe cases, etc.). Block 101 may include providing a prompt to a subject based on a stored complexity level associated with the subject (e.g., tracking the subject's progress in therapy, language learning, etc.), a selected complexity level (e.g., by a therapist for a patient, or by a subject in a self-guided therapy).

Block 101 may include receiving the speech response by recording a subject responding to the prompt. For example, block 101 may include recording audiovisual data (e.g., a video) of a subject speaking about a prompt, recording audio data (e.g., voice recording) of the subject responding to the prompt, a transcription of a subject speaking about a prompt (e.g., via a live transcription process or transcription of audio/audiovisual data, such as by a speech-to-text model). Block 101 may be performed by a user device, a server, combinations thereof, or any other suitable execution system.

The process 100 further include block 102, which includes comparing the speech response to a previous speech response of the subject. For example, block 102 may include comparing the speech response to a previous speech response from the subject obtained during an earlier session, to a previous speech response from a current session, etc. For instance, block 102 may include retrieving previous speech data from a data structure, such as a database or content distribution network. Block 102 may include retrieving prior speech recordings, measures derived from prior speech recordings, a learning curve based on the prior speech response, etc.

Block 102 may include computing a speech performance-related measure for the speech response. For instance, block 102 may include computing linguistic measures, auditory measures, or any suitable speech therapy metric. As examples, block 102 may include computing speech rate (e.g., number of correct words per unit time, etc.), speech accuracy, correct information units (CIUs), global coherence (e.g., the relevance to the speech response to the overall topic, picture, prompt, etc.), local coherence (e.g., logical flow between speech responses/prompts, etc.), speech latency, speech initiation latency, etc.

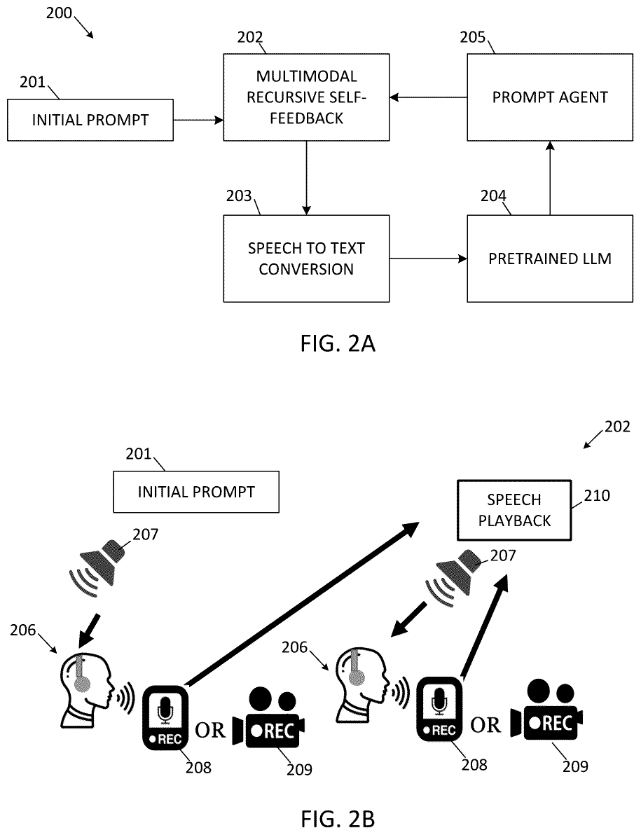

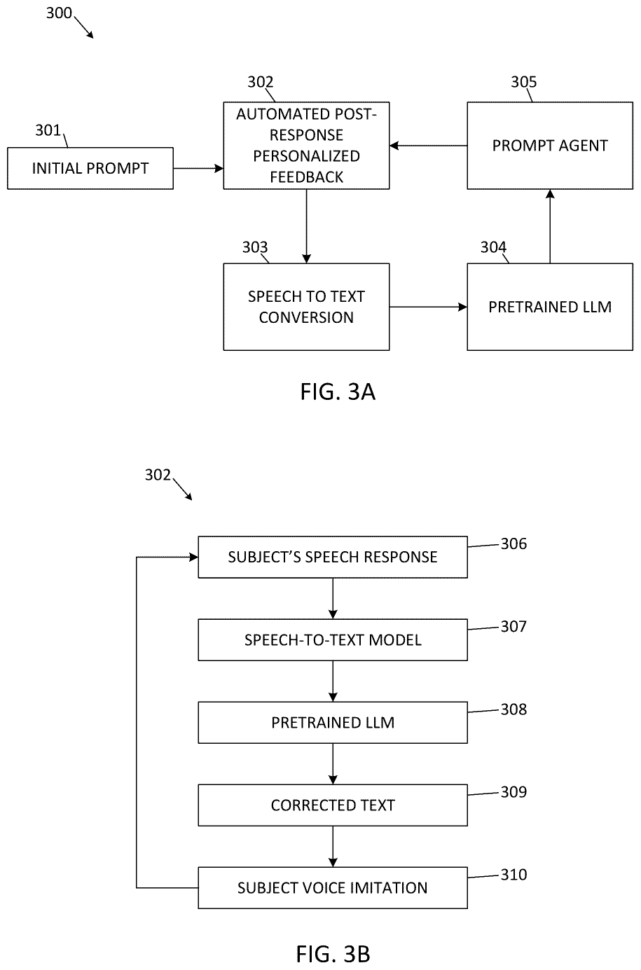

As discussed below, some implementations may include a recursive feedback step where a subject repeatedly attempts to respond to a prompt after their speech is played back to them over a number of iterations or a voice imitation of the subject is played back to them over a number of iterations (e.g., FIG. 2, block 202, FIG. 3, block 303). In some such implementations, block 102 may include comparing the speech response to previous speech responses from an iterative feedback process. For instance, a change in the subject's speech rate over N attempts at a prompt or a change in the subject's speech accuracy rate over N prompt attempts may be compared to a threshold learning curve.

The process 100 may further include block 103, which includes determining a complexity for a subsequent prompt based on the comparison in block 102. Block 103 may include determining whether to increase the complexity of a subsequent prompt, decrease the complexity of a subsequent prompt, or maintain the same complexity as the current prompt. Prompt complexity may be associated with various prompt parameters, such as degree of stimuli complexity (e.g., easily recognizable pictures or short narratives/questions that encourage basic descriptions vs more complex pictures, narratives/questions that encourage more complex or nuanced descriptions); degree of linguistic complexity (e.g., simpler prompts that can be responded to with short phrases, yes/no answers, etc., vs prompts that encourage more complex language structures, descriptive phrases, etc.); varying degrees of elaboration on prior prompt responses (e.g., whether a prompt should move to a new stimulus/ask about a different aspect of a stimulus, etc. vs a prompt that requests additional detail or elaboration on a prior response/prompt); degree of narrative development (e.g., a prompt that requests the subject elaborate what they this will happen next in a scene vs a prompt that requests the subject elaborate on a sequence of subsequent events); or any other suitable mode of prompt complexity in response elaboration therapy.

In some examples, block 103 may include incrementing a prompt complexity based on the comparison in block 102. For instance, if the speech response of block 101 meets a threshold degree of improvement over the previous response, then block 103 may include increasing the prompt complexity. If the speech response of block 101 is below a threshold degree of improvement compared to the previous response, then block 103 may include decreasing the prompt complexity. Similarly, if the speech response of block 101 is within a threshold performance range compared to the previous response, then block 103 may include maintaining the prompt complexity. As an example, an initial prompt (e.g., at the beginning of a course of therapy, at the beginning of a session, etc.) may be set to a lowest complexity as a starting point (e.g., to produce prompts for severe cases). In this example, increasing complexity may proceed from prompts for sever cases to prompts for moderate/severe cases to prompts for moderate cases, to prompts for mild cases, and finally to prompts for regular speakers.

Block 104 may include applying a language model to the speech response to generate a corrected speech response. For example, block 104 may include applying a pretrained language model, such as a pretrained large language model (LLM) to the speech response. In some cases, block 104 may include transcribing the speech response into text and inputting the transcribed text to the LLM. In other cases, block 104 may include inputting an audio speech recording to the LLM. The LLM may be pretrained to translate speech responses into elaborated speech responses for subsequent output to the subject. For instance, a subject viewing a picture of a child blowing out birthday candles on a cake may provide a speech response such as “Boy . . . cake” and the corrected speech response may be an elaboration of that speech response, such as “A boy is having a cake.” The LLM may be further pretrained to generate corrected speech responses in a question format or other format for inclusion in a subsequent prompt. For instance, in the previous example, the corrected speech response might be “Why is the boy having cake?” or “what is the boy doing with the cake?”, etc.

Block 105 may include generating a subsequent prompt for the subject based on the determined complexity and the corrected speech response. For example, block 105 may include generating a prompt to elaborate a previous response using the corrected text of the subject's speech based on the complexity determine din block 103. For instance, in the above example, if the complexity were determined to be for a severe case (e.g., low complexity), the prompt might be “yes, the boy is having cake, what is he doing with the cake?” In some examples, block 105 may comprise generating a prompt via a generative artificial intelligence model (e.g., an LLM, such as the LLM used in block 104, or a second pre-trained LLM). In further examples, block 105 may comprise generating a prompt in an other suitable manner, such as selecting a pre-scripted prompt from a stored set of prompts that have been segmented based on complexity.

Block 106 may include providing the subsequent prompt to the subject to receive a subsequent speech response. For instance, block 106 may applying a text-to-speech model to prompt text generated in block 106 to generate a spoken prompt. In some examples, part or all of the prompt may be generated in a voice imitation of the subject. For instance, the corrected speech response generated in block 104 may be converted to a spoken audio imitating the subject's voice and a question portion of the prompt may be converted to spoken audio in a different voice. As further examples, prompts may be provided in other formats, such as text or pictures. For instance, block 105 may include generating a picture based on the corrected speech response and determined complexity (e.g., by a pretrained text-to-image model such as a large language generative pre-trained transformer). In some cases, a therapy session may continue such that the subject's response to the subsequent prompt may be provided as a speech response for block 101 in a subsequent performance the method.

FIGS. 2A-2B illustrate example aspects of a speech therapy process 200 that includes multimodal recursive self-feedback and autonomous complexity adaptation. For example, the illustrated process may be performed as an implementation of a process illustrated in FIGS. 1-5.

At block 201, an initial prompt is presented to the subject 206. For example, the system may deliver an auditory or visual prompt for the scripted statement through the mobile application, such as by displaying scripted statements (e.g., sentences, questions, clauses, phrases, words, etc.) in textual form on a screen, or by audibly playing 207 a recording of someone ready the scripted statements, or by having a native digital assistant or text to speech engine reproduce the scripted statements via a speaker. The patient 206 may then articulate a response, which is recorded using the device's microphone. In some examples, the application may allow a user to press (and/or hold) a button on the screen or device, throughout the period of time in which the user intends to speak, so as to engage the microphone and provide a clue as to whether a given pause or silence was meant to be the conclusion of an uttered statement or not. The system may store the recorded response locally or upload it to a cloud-based storage system for further processing. In some implementations, the initial prompt may be based on the results of a prior session—for example, the initial prompt may be determined by prompt agent 204 based on a prior state of acoustic or linguistic measures for the subject, etc.

At block 202, multimodal recursive self-feedback (RSF training) may be performed, as described below with respect to FIG. [BELOW]. In summary, the initial prompt 201 may be played to the subject via a speaker 207, or otherwise presented to the patient. Patient 206's initial response may be recorded by a user device 208/209 (e.g., via a microphone or microphone & camera of a mobile device, laptop, etc.). The recorded speech may then be played back 210 to the patient 206 via a speaker 207 (e.g., a user device speaker), and the patient 206 may attempt to repeat their previous speech in an improved manner. The repeated speech is recorded via a user device 208/209 and then played back again. The number of feedback repetitions may be determined in view of various parameters and factors, as discussed below. The final output of self-feedback process 202 may serve as a speech response as discussed with respect to block 101 of FIG. 1.

The number of feedback cycles in RSF training may vary depending on patient accuracy, difficulty level, and engagement patterns. In some embodiments, process 200 may dynamically determine the number of cycles based on the severity of speech deviations, past performance trends, and clinician-defined therapy goals. For example, if the system detects frequent articulation errors in a specific phoneme, it may increase the number of replay attempts before moving forward. Conversely, if the patient consistently demonstrates improvement, process 200 may reduce the number of iterations or introduce randomized verification cycles to assess retention. Some embodiments may also include adaptive reinforcement mechanisms that adjust feedback intensity based on session progression. For instance, initial training sessions may provide extensive feedback, while later sessions may gradually reduce reliance on replay mechanisms to encourage independent speech monitoring.

At block 203, the speech output of block 202 is formatted for inputting to a pretrained LLM 205. For instance, the output may be transcribed via a speech to text model. The transcribed speech may be input to a pretrained LLM in block 205. Additionally, the transcribed speech may be provided to a prompt agent in block 205 for complexity determination. In some examples, block 203 may be performed on a plurality of speech recording from the multimodal recursive self-feedback session 202. For instance, block 203 may comprise transcribing multiple speech responses across a session to support prompt agent 205 determining a learning curve/learning rate of subject 206.

At block 204, the formatted output of block 203 is provided to a pretrained LLM 204 to generate a corrected speech output. For example, the corrected speech output may be generated as described above with respect to block 104 of FIG. 1. Similarly, at block 205, a prompt agent (e.g., a computer process executed by a server, the subject's user device, etc.) generates a customized prompt based on a customized prompt complexity, such as described above with respect to blocks 103 and 105 of FIG. 1.

The iteratively generated prompt from block 205 may then be provided to subject 206, such as via a speaker 207 or other modality (e.g., a modality as described with respect to block 201). Process 200 may then repeat from block 202 to provide an iterative agent-subject interaction to customize prompt complexity.

FIGS. 3A-B illustrate example aspects of a speech therapy process 300 that includes automated post-response personalized feedback and autonomous complexity adaptation. For example, the illustrated process may be performed as an implementation of a process illustrated in FIGS. 1-5. In some examples, process 300 may be an alternative implementation to process 200. In other examples, process 300 may be performed in conjunction with process 200. For instance, a speech therapy application may have a selectable option to perform either process 200 or process 300. As another example, multimodal recursive self-feedback 202 may be performed in some iterations and automated post-response personalized feedback 302 may be performed in other iterations. For example, prompt agent 305 or other process may determine whether to implement block 202 or block 302 based on factors such as current prompt complexity, patient history, etc.

Process 300 may proceed substantially as described with respect to process 200. For example, block 301 may be implemented as described with respect to block 201, block 303 may be implemented as described with respect to block 203, block 304 may be implemented as described with respect to block 204, and block 305 may be implemented as described with respect to block 205.

At block 302, an automated post-response personalized feedback process may be performed as illustrated with respect to FIG. 3B. At block 306, the subject's speech response to a prompt is received. For example, block 306 may include recording a speech response via a user device executing a therapy application, such as a mobile device, personal computer, etc.

At block 307, the subject's speech response is transcribed to text via a speech-to-text model. The speech-to-text model may be the same model as is applied in block 303 or the speech-to-text model may be a second model (e.g., they may be separate instances of a commonly trained model or two differently trained models). At block 308, a pretrained LLM is applied to the speech-to-text model. The pretrained LLM may be the same model as applied in block 304 or may be a second LLM (e.g., they may be separate instances of a commonly trained model or two differently trained models).

At block 309, the LLM outputs a corrected speech response. For example, the corrected speech response may be a grammatical or other linguistic correction of the speech response 306. For example, the corrected speech response may comprise an elaboration of the speech response (e.g., an input such as “man . . . get . . . hair” may be corrected to an output such as “a man is getting a haircut”).

At block 310, a text-to-speech model is applied to the corrected speech response to generate an audio version of the corrected speech response. In some cases, the corrected speech response may be generated in an imitation of the subject's voice. For example, a text-to-speech model may be trained using samples of the subject's voice to generate audio in a similar sounding voice. The corrected audio may then be played to the subject to conduct another iteration of process 302. After a certain number of iterations, the speech response (output by block 306 at a last iteration) may then be input to block 303. In other examples, blocks 303 and 304 may be implementations of blocks 307-309. For example, the corrected text output from block 309 may be provided to a prompt agent service in block 305. In addition, the raw/uncorrected audio of the user's actual Nth speech production attempt may also be played back to the user, before or after the corrected speech, or instead of the corrected speech, or either can be played upon user request (which involves the user cognitively becoming engaged in determining their own treatment structure as of the Nth, Nth+1, Nth+x attempt. In In further embodiments, the LLM may be prompted to identify the types of errors that the user is making, and categorize them by a set of predefined criteria such as types of sentence structures, particular word sequences, or words with given phonemes or phoneme sequences. In other embodiments, a secondary neural network may group errors together in an unsupervised fashion and develop hallmarks of user errors without being limited to predefined categories. Based on the user's types of errors, the system can generate scripts to be spoken by the user that emphasize and encourage correction of these common errors.

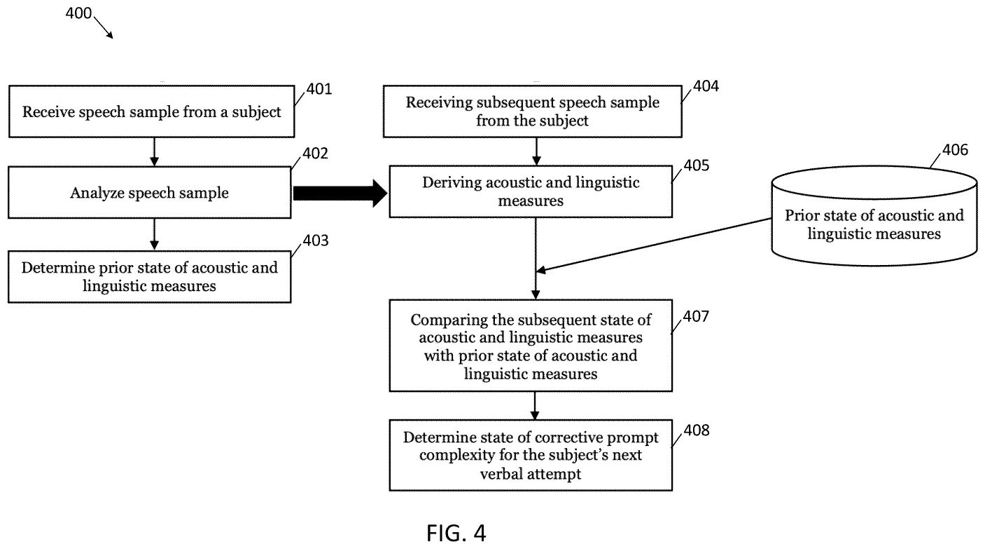

FIG. 4 illustrates an example process 400 of customizing prompt complexity for a speech therapy patient. For example, process 400 may comprise implementations of aspects of processes 100, 200, 300. In some embodiments, process 400 may be performed by a prompt agent service, such as described with respect to blocks 205, 305 of FIG. 2 or 3. In certain embodiments software running on the user's mobile device or a connected resource (e.g., cloud or remote server) may automatically and adaptively adjust the type or characteristics of the scripts, questions, and/or prompts provided for the user which are intended to elicit spoken responses.

A database may be provided that contains information describing prompt segmentations. In some cases, the prompt segmentations may include banks of increasingly-difficult or complex scripts or prompts so that a user's therapy sessions can match a user's improvement. In other cases, the prompt segmentations may instead include prompts that would be provided to an LLM to dictate attributes of scripts or user-prompts that it should generate.

The level of difficulty or complexity can be determined based upon a user profile that contains performance tracking metrics. These metrics may be assessed as described above with respect to the inventors' studies, or may include predefined factors that can readily be quantified and evaluated automatically by a software application (e.g., running locally on the user's device). For example, speech rate and speech accuracy may be metrics that are evaluated, and based upon a normalized scaling of the user's performance, different levels of prompts may be selected from the prompt segmentation database. Additionally, a user's metrics may be utilized to determine a learning curve or improvement profile. In such embodiments, rather than provide the user with scripts or prompts that fall within a given level, the user's curve can take into account pace of improvement and utilize the user's performance over time to adjust percentages of prompts or scripts that are chosen from multiple prompt segmentation levels.

At block 401, process 400 may include receiving a speech sample from a subject. For example, block 401 may comprise receiving an audio speech sample, a transcribed speech sample, etc. Block 401 may be performed as described with respect to blocks 101, 201, 303. In some cases, these blocks may be performed by a user device (e.g., a subject's mobile device or personal computer), or by a server (e.g., block 401 may comprise receiving a speech sample transmitted by a user device). As another example, block 401 may comprise receiving other speech samples, such as speech samples obtained during an initial patient evaluation, etc.

At block 402, the speech response received in block 401 is analyzed. For example, the speech sample may be analyzed as described with respect to block 103. For instance, block 402 may comprise deriving acoustic or linguistic measures for the sample, such as computing speech rate (e.g., number of correct words per unit time, etc.), speech accuracy, correct information units (CIUs), global coherence (e.g., the relevance to the speech response to the overall topic, picture, prompt, etc.), local coherence (e.g., logical flow between speech responses/prompts, etc.), speech latency, speech initiation latency, etc. In some cases, block 402 may include performing audio processing on the speech sample (e.g., to derive acoustic measures) and may include performing text processing (e.g., via speech-to-text) or speech-content processing (e.g., to derive linguistic measures). At block 403, the measures derived in block 402 may be stored in a data structure 406 for comparison to subsequent speech sample analyses.

At block 404, a subsequent speech sample is received from the subject. For example, the subsequent speech sample may be an initial sample received during a therapy session (e.g., where the speech sample in block 401 represents a speech sample from a previous session, initial evaluation session, etc.). As another example, block 404 may comprise receiving a speech output after a feedback process (202, 302) or receiving a speech output from an intermediary iteration of the feedback process.

At block 405, the subsequent speech sample is analyzed to derive acoustic or linguistic measures, as described above. In some cases, these measures may be stored in data structure 406 (e.g., for a subsequent iteration of process 400 in the current therapy session or a future therapy session).

At block 407, the measures derived in block 405 are compared to prior measures retrieved from data structure 406. For example, block 407 may comprise comparing current measures to measures from a preceding iteration of process 200 or 300, from a sequence of measures (e.g., determined from a sequence of RSF iterations 202 or automated personalized feedback iterations 302). In some examples, block 407 may comprise comparing current measures to a plurality of previous measures. For example, block 407 may comprise determining whether a current speech sample is within a designated threshold of a trend/learning curve determined from previous measures.

At block 408, process 400 determines a complexity state for a corrective prompt for the subject's next verbal attempt. For instance, block 408 may be performed as described with respect to block 103.

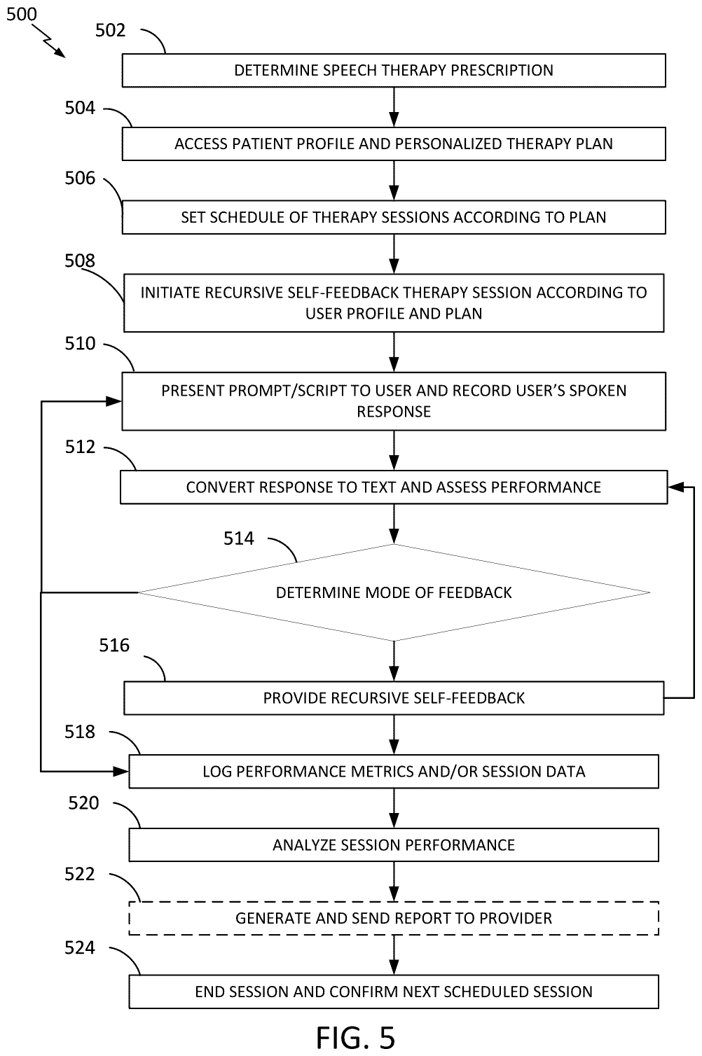

Referring now to FIG. 5, a process 500 is illustrated, depicting a general example for actions involved in a method for providing speech therapy to a patient. For example, any or all of the processes described above may be performed in an implementation of process 500. Process 500 may be implemented by a computing system that includes one or more servers, mobile applications, cloud-based processing resources, and data storage systems. In some embodiments, portions of process 500 may be executed on a patient's mobile device, while other portions may be executed on remote computing infrastructure managed by a therapy service provider or EMR.

At block 502, process 500 determines a therapy prescription for a person experiencing a speech condition such as aphasia. The therapy prescription need not be a “prescription” in the sense of a licensed physician prescribing it, but rather may also simply be a manner in which to detail and specify its parameters. The therapy prescription may define parameters such as therapy frequency, session duration, scripted statements to be used, speech fluency targets, topics of interest, age/comprehension level, and feedback customization.

For example, in some embodiments, process 500 may determine the prescription via input from the person's healthcare provider(s), such as by providing a secure web-based clinician portal into which a healthcare provider can input or configure the prescription in the form of therapy session settings. Process 500, in some embodiments, can allow the provider to log into the portal (such as with multi-factor authentication, or via EMR credentials), where the provider can access a dashboard that displays patient profile(s), historical progress data, and customizable therapy parameters. The portal may guide the healthcare provided to define the prescription settings through a structured user interface, including drop-down menus, toggles, and text fields to allow configuration of frequency, session duration, scripted statement complexity, feedback sensitivity, and patient engagement preferences. Process 500 may then encrypt and transmit the configured settings to the patient's mobile application via a cloud-based server, ensuring secure deployment of the prescribed therapy, or may save such settings to the patient's profile such that the settings are utilized when the patient logs into a particular app on their mobile device.

Alternatively, process 500 may autonomously determine a therapy prescription through an initial speech assessment within the mobile application. In such an embodiment, process 500 presents the patient with a structured evaluation sequence, prompting them to repeat a bank of scripted statements stored either locally on the device or dynamically retrieved from a cloud-based repository. The statements may be designed to increment in linguistic complexity, ranging from simple phoneme repetitions to grammatically complex sentences. Process 500 may thus utilize speech-to-text conversion and phoneme similarity analysis to assess the patient's fluency, accuracy, and response time. Based on these metrics, process 500 may assign an initial prompt complexity, and generate a personalized therapy plan. Additionally, process 500 may include an onboarding questionnaire for the patient to define therapy preferences, such as desired engagement level, comfort with difficulty adjustments, and availability for scheduled sessions. These inputs may further refine the prescribed therapy settings.

In some implementations, process 500 may alternatively (or additionally) provide adaptive therapy prescription adjustments, dynamically revising and updating certain parameters of the prescription based on ongoing patient performance, engagement, adherence, and progress. Process 500 may regularly re-evaluate the patient's accuracy and progress, so as to inform periodic assessments of whether increasing or decreasing session intensity may be needed or beneficial. The patient may or may not have visibility into the specific algorithmic adjustments, depending on the application's transparency settings.

Some embodiments may include an option for a patient/user to override prescription settings, such as allowing patients to adjust certain parameters (entirely, and/or within predefined bounds).

At block 504, process 500 loads the patient profile and personalized therapy plan. In some embodiments, process 500 may retrieve patient-specific data from a cloud-based storage system or a local database on the patient's device. The patient profile may include data such as prior session history, speech impairment severity levels, baseline fluency assessments, and therapy preferences. In some cases, the patient profile may include linguistic or acoustic measures, such as stored in a data structure 406, or some parameter derived therefrom. Some implementations may allow healthcare providers to update the patient profile remotely through a secure portal, while other implementations may permit automated updates based on patient performance in prior sessions. The therapy plan may be structured dynamically, adjusting scripted statement selection, feedback intensity, and session duration based on real-time patient progress.

At block 506, process 500 schedules therapy sessions. In some implementations, process 500 may generate a predefined schedule based on clinician recommendations or patient availability settings. The scheduling module may factor in historical patient adherence patterns and dynamically adjust session timing to maximize participation. Notifications may be sent through various communication channels such as push notifications in the mobile application, SMS, or email reminders. In some embodiments, process 500 may provide rescheduling options, allowing the patient to adjust session times within predefined limits to maintain engagement.

Process 500 may also take into account the inventor's findings from experimental studies regarding continuous vs. discontinuous scheduling of therapy sessions during a given day, when developing the schedule/prescription. For example, in some implementations, process 500 may encourage the user to adopt and adhere to a session schedule that intersperses therapy sessions throughout the day, or at least breaks them up so that they do not comprise one long session each day. Discontinuous sessions, which entail predefined or user-directed/spontaneous spacing of therapy sessions throughout the day, rather than a single intensive session, leads to better long-term retention and speech fluency improvements. Thus, process 500 may suggest spaced scheduling, and/or may prompt or notify the user to stop sessions that are running long, or to start sessions after some period of time has gone by. Additionally, the system may involve an application that integrates with content applications, such as news or sports apps, social media, etc., and interrupt the user's browsing by highlighting text in an article or post and asking the user to speak the text and do a spontaneous training session involving content the user was already viewing. The system may adaptively adjust session timing based on patient performance trends, prioritizing spaced practice schedules when beneficial.

At block 508, process 500 initiates a therapy session via the mobile application. In some embodiments, process 500 may verify patient identity through biometric authentication or secure login credentials before retrieving therapy session parameters. The system may generate or load scripted statements, and relevant speech exercises from a cloud-based server or local storage. Some implementations may incorporate an introductory session guide, presenting an overview of the upcoming session objectives and expected outcomes before the session begins.

The therapy session may be a delivered via a dedicated mobile app, such as described below in reference to the validation studies. The app may allow a user to start, pause, and stop the therapy session, and may present a simplified interface so as not to be distracting.

At block 510, process 500 presents a prompt, such as a generated or scripted statement, and captures the patient's verbal response. The system may deliver an auditory or visual prompt through the mobile application, such as by displaying statements (e.g., sentences, questions, clauses, phrases, words, etc.) in textual form on a screen, or by audibly play a recording of someone reading the scripted statements, or by having a native digital assistant or text to speech engine reproduce the scripted statements via a speaker. In some such systems, the produced scripted statements may be generated in an imitation of the patient's voice. For example, block 510 may be performed as described with respect to blocks 101, 201, 301. In some cases, block 510 may be performed following a previous iteration of such a process, in which block 510 may be performed as described with respect to blocks 106, 205, 305. The patient may then articulate a response, which is recorded using the device's microphone. Additionally, the articulated response may be recorded using the device's camera to generate an audiovisual recording. In some examples, the application may allow a user to press (and/or hold) a button on the screen or device, throughout the period of time in which the user intends to speak, so as to engage the microphone and provide a clue as to whether a given pause or silence was meant to be the conclusion of an uttered statement or not. The system may store the recorded response locally or upload it to a cloud-based storage system for further processing.

At block 512, process 500 converts the recorded speech to text and assesses the accuracy of the response. The system may utilize speech-to-text processing combined with phoneme similarity analysis to compare the spoken response against the expected scripted statement. Accuracy may be determined based on phonetic precision, timing, and fluency. For example, the analysis may be performed as described with respect to blocks 103, 403, 405, etc.

At block 514, process 500 determines feedback mode based on the accuracy assessment. If the response meets predefined accuracy criteria, process 500 may indicate correctness and proceed to the next scripted statement. If inaccuracies are detected, process 500 may determine whether to provide recursive feedback or other corrective mechanisms based on past error trends and patient performance history.

At block 516, process 500 provides iterative training for incorrect responses. For example, block 516 may be performed as described with respect to block 202 to provide RSF. The system may replay the patient's prior response, allowing self-monitoring and correction. In some implementations, the RSF mechanism may highlight differences between the patient's response and the expected phrase through visual overlays or audio modulation. The system may provide multiple types of self-feedback, such as slowing down the original model response, breaking it into phoneme-by-phoneme replay, or offering real-time pitch and articulation guidance.

In another example, block 516 may be performed as described with respect to block 302 for personalized corrected feedback. The system may generate a corrected response based on the patient's prior response, such as in an imitation of the patient voice, allowing self-monitoring and correction as well as a goal/target for speech production. For instance, hearing the corrected response in their own voice may assist various aspects of future speech production, such as conceptualization, word selection, grammatical planning, articulation planning, motor execution, etc., or may provide improved auditory feedback. In some implementations, the speech-corrected feedback mechanism may highlight differences between the patient's response and the expected phrase through visual overlays or audio modulation. The system may provide multiple types of self-feedback, such as slowing down the corrected model response, breaking it into phoneme-by-phoneme replay, or offering real-time pitch and articulation guidance.

Alternative methods may involve interactive prompts that guide the patient through gradual correction, leveraging AI-driven phoneme modeling to provide hints. The system may display the original scripted statement alongside the patient's transcribed response, allowing for a direct textual comparison. Additionally, a color-coded accuracy indicator may be used to highlight specific words or phonemes that need improvement. For instance, indicators may be used to highlight words or phonemes that were added/changed in the corrected speech feedback. In some implementations, process 500 may provide a user-selectable button or automated prompt to initiate playback of their prior response or corrected response, allowing the patient to hear their speech in contrast to the target phrase.

The number of feedback cycles may vary depending on patient accuracy, difficulty level, and engagement patterns. In some embodiments, process 500 may dynamically determine the number of cycles based on the severity of speech deviations, past performance trends, and clinician-defined therapy goals. For example, if the system detects frequent articulation errors in a specific phoneme, it may increase the number of replay attempts before moving forward. Conversely, if the patient consistently demonstrates improvement, process 500 may reduce the number of iterations or introduce randomized verification cycles to assess retention.

Additionally, block 516 may be performed to provide additional iterations having adaptive prompt complexity. For example, block 516 may include blocks 203-205 of FIG. 2, blocks 303-305 of FIG. 3, including process 400 of FIG. 4.

Some embodiments may also include adaptive reinforcement mechanisms that adjust feedback intensity based on session progression. For instance, initial training sessions may provide extensive feedback, while later sessions may gradually reduce reliance on replay mechanisms to encourage independent speech monitoring.

At block 518, process 500 logs session data and performance metrics. The system may record total session duration, number of iterations completed, speech fluency trends, and patient adherence to therapy schedules, storing the data in a cloud-based or local storage system for later review.

At block 520, process 500 analyzes session performance and adjusts the therapy plan accordingly. Updates may include modifying difficulty levels, prompt complexity levels, feedback intensity, or session duration based on real-time patient progress.

At block 522, process 500 generates a report summarizing patient progress and, in some embodiments, transmits it to a healthcare provider.

At block 524, process 500 ends the session and schedules the next therapy activity based on prescribed parameters and real-time adjustments.

### Example Systems, Networks, and Platforms

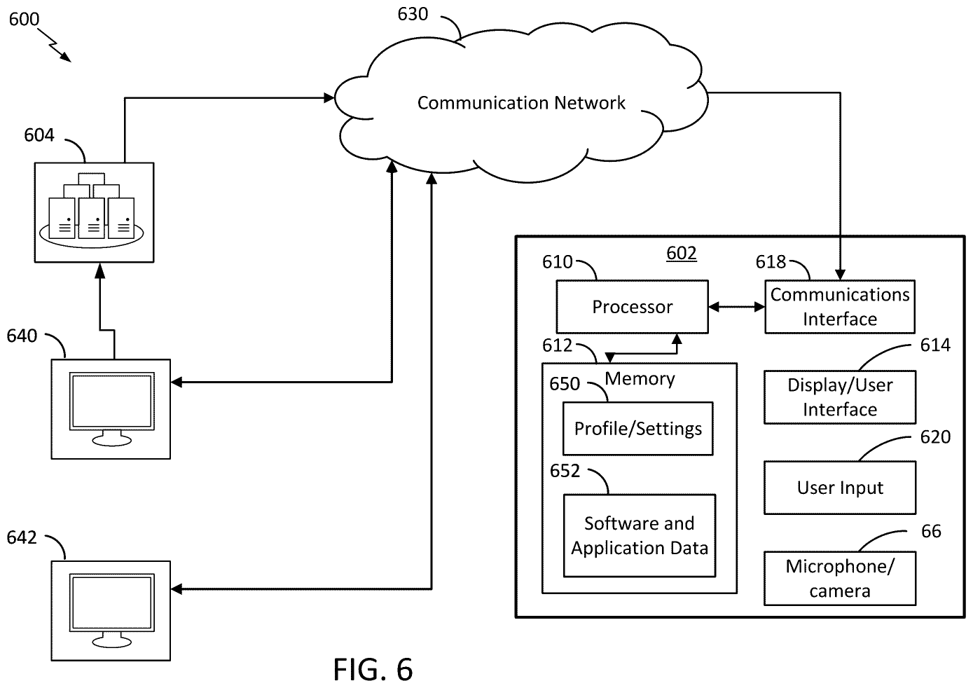

FIG. 6 is a conceptual block diagram illustrating a system 600 for implementing the processes described above. In one respect, system 600 can be thought of as an integrated platform for facilitating, monitoring, and managing adaptive prompt complexity speech therapy. In another respect, system 600 may represent a distributed architecture where different computational tasks are executed across various devices and cloud-based infrastructure.

As shown, system 600 includes a mobile device 602, which may be a smartphone, tablet, or specialized speech therapy device. Mobile device 602 may execute a therapy application that presents scripted statements, records patient responses, provides recursive self-feedback, corrected speech feedback, adaptive prompt complexity, and logs session data. Mobile device 602 may include subcomponents such as a processor 610, which may be a general-purpose processor, application-specific integrated circuit (ASIC), graphics processing unit (GPU), or other dedicated hardware optimized for speech processing and machine learning tasks. A memory 612, which may be volatile (RAM) or non-volatile (ROM, flash storage, SSD), can store patient profiles, therapy settings, and application data. Additionally, mobile device 602 includes a display screen 614, a microphone 616 for capturing patient speech, a user input 618 (e.g., touchscreen, keyboard, or voice commands), and a communications interface 620, which may support Wi-Fi, Bluetooth, cellular (3G, 4G, 5G), or other network connectivity options to transmit data to server 604 or other remote systems.

System 600 further includes a server 604, which may facilitate therapy prescription management, data processing, and analytics. Server 604 may include multiple processing cores, a storage 622 for storing therapy prescriptions, patient progress logs, and historical speech data, and one or more network interfaces 624 for secure data transmission. Storage 622 may comprise a data structure 406 as described with respect to FIG. 4. In some embodiments, server 604 may integrate with an electronic medical records (EMR) system to provide seamless access to patient data for healthcare providers. Server 604 may also host a web-based provider portal, allowing clinicians to remotely monitor patient progress, configure therapy settings, and review AI-generated reports on speech accuracy trends, fluency improvements, and engagement levels.

Server 604 may further include executable services such as language models, transformer models (e.g., text-to-speech, speech-to-text, speech/text-to-image, etc.). In some cases, server 604 may store patient data associated with the models (e.g., patient-specific model parameters), or patient-specific model instances. For example, server 604 may store samples of, or representations of, the patient's voice for a voice imitation text-to-speech model. As another example, server 604 may store an instance of a text-to-speech model that is pre-trained to imitate the patient's voice. Server 604 may store language models as described above, such as speech-corrective language models, prompt-elaboration language models, etc.

A workstation 606 may be provided for healthcare providers or speech-language pathologists to configure therapy prescriptions and review patient progress. Workstation 606 may be a standalone computer, a cloud-based interface, or an integrated component of an EMR system. Workstation 606 may include a graphical user interface (GUI) that displays patient session logs, adherence reports, and automated insights generated by server 604. In some implementations, workstation 606 may allow providers to fine-tune therapy plans, adjust scripted statement complexity, and manually override automated prescription settings.

A communication network 608 connects mobile device 602, server 604, and workstation 606. Communication network 608 may include the Internet, cellular networks, local area networks (LANs), or other communication pathways. The network may facilitate real-time data exchange, remote therapy session scheduling, and software updates for the mobile application. The system may support end-to-end encryption protocols to ensure data security and privacy compliance.

In some embodiments, system 600 may further include cloud-based storage and processing resources, enabling scalable data management and computationally intensive operations such as natural language processing, phoneme similarity analysis, and automated speech error detection. Cloud services may allow seamless syncing of therapy progress across multiple devices, ensuring that therapy sessions remain uninterrupted even if a patient switches devices.

### Example Data and Validation Experiments

### Example Language Model

The inventor has conducted a feasibility study on the performance of a response elaboration AI model (“Re-Agent”) across semantic parameters. For example, such an AI model may be applied in various steps of embodiments. For example, the model may perform any or all of blocks 104-105, 203-205; 303-305, 307-310, 516, etc. This work demonstrates the feasibility of applying LLM and speech technologies to treatment of communication disorders. Re-Agent is effective across different types of stimuli and CoT best optimizes its performance. Future research will involve more SLP testers and additional performance metrics, with the goal of optimizing Re-Agent for use with PWA.

Re-Agent is based on a large language model (LLM), and its effectiveness depends on the prompting technique used. For clinical relevance, Re-Agent needs to help users expand their responses to stimuli with both highly constrained (e.g., pictures) and less constrained (e.g., topics) semantic parameters. Therefore, this study evaluates Re-Agent's performance across varying semantic parameters and prompting techniques.

Re-Agent was developed using GPT-40 as its base LLM, supplemented with external speech-to-text and text-to-speech models. Two prompt templates-chain-of-thought (CoT) and zero-shot-were designed to instruct the LLM to implement RET in English. Data were gathered from interactions between Re-Agent and a certified SLP trained to simulate aphasic speech. The SLP engaged in eight conversational turns per stimulus with Re-Agent, via a desktop computer, across four conditions: CoT+pictures, CoT+topics, zero-shot+pictures, and zero-shot+topics. Each condition involved 10 stimuli, with breaks between conditions to prevent fatigue. The study analyzed the number and proportion of Correct Information Units (CIUs) produced by the SLP, as well as the global and local coherence of Re-Agent's prompts. CIUs are context-relevant words excluding fillers and repetitions, while global coherence measures the relevance of Re-Agent's prompts to the overall topic or picture, and local coherence assesses the logical flow between consecutive prompts. These measures are used for conversational analysis in clinical aphasiology.

Overall, CoT and pictures led to the best performance relative to the other conditions. The findings revealed that the SLP's responses were slightly more informative in the picture conditions (mean CIU=3.24; 75% CIUs) than in the topic conditions (mean CIU=2.90; 74% CIUs). The CoT conditions produced more informative CIUs per utterance (mean CIU=3.04; 76% CIUs) compared to the zero-shot conditions (mean CIU=2.63; 73% CIUs). The combination of CoT and pictures yielded the most informative utterances (mean CIU=3.67; 76% CIUs), while zero-shot+topics resulted in the least informative responses (mean CIU=2.23; 68% CIUs). Both global and local coherence scores were consistently high across all conditions.

The inventor and their team have conducted a variety of studies, looking at several different comparisons and outcome measures, to validate various techniques that are appliable to the described technology. This Experiments section sets forth a discussion of those studies and findings, but should not be understood as limiting of the more general scope of this disclosure. Furthermore, while the systems and methods employed in these studies may or may not have included all of the features, alternatives, equipment, etc. that are contemplated herein, the studies still nonetheless validate that the subject matter hereof represents a clear improvement in the field and a clear improvement over prior methods for providing speech therapy.

The team believed, based on analysis of reported data, that PWNA have difficulties with using self-feedback in real-time to improve their language production. For instance, prior studies have examined vocal compensation, i.e., responding to pitch shift, in PWNA through the delayed or altered auditory feedback paradigm. These studies show, for example, that PWNA have difficulties with real-time error processing and correction abilities. Interestingly, the team found that PWNA can benefit from script-based therapy with offline (i.e., post-production) playback of their own speech, because it provides PWNA more time to monitor and correct their own speech errors and improve their language production when repeating sentences.

In their validation studies, the team took a novel approach to enabling a self-feedback form of therapy. Instead of providing playback of PWNA speech after each time they imitate a proficient speech model, the studies allowed self-feedback to propagate recursively for each spoken sentence, without subsequent guidance by an SLP. This recursive self-feedback technique involves the application of several self-feedback loops during performance of a specific task or learning a specific behavior. For the initial study, the target behavior was script reproduction. In this manner, the team provided PWNA with opportunities to gradually monitor, detect, minimize, or correct errors and improve their language production over time. Note that the term ‘recursive’ includes the concept that the output of PWNA performance can become the reference (input) for the next performance, and so forth, in an automated closed feedback loop.

Both the control and recursive self-feedback trainings were based on computerized script-based treatments. Script-based treatments allow for attaining automaticity in the production of personalized scripts through improving accuracy and speaking rate in the production of the scripts by PWNA. A clinician or virtual speaker provides a model of the speaking rate and accuracy, and the patients attempt to imitate the model and to achieve automaticity in the imitation. To achieve this, computerized script-based treatments such as AphasiaScript® and Speech Entrainment have been shown to be effective for improving script production in PWNA. For instance, AphasiaScript® uses repetition of sentences or phrases from personalized scripts with the aid of real-time feedback (speech unison) and offline feedback from a virtual speaker. Speech Entrainment uses a tablet to deliver prerecorded script production of a proficient human speaker to engage PWNA during speech unison. Speech Entrainment with audiovisual or audio-only entrainment was more effective than script production without entrainment and both forms of entrainment were more beneficial for people with nonfluent aphasia than those with fluent aphasia. For their initial study, the team used a computerized script-based approach for treatments, and used smartphones to allow for greater flexibility and better convenience compared to tablet-based treatments.

For these studies, the team used speaking rate of accurate script produced, and introduced speech initiation latency as a measure of effortful language production. Speaking rate and speech initiation latency of accurate utterances were assessed in terms of the percent of sentence produced within a script, because it would take PWNA a shorter duration to produce an inaccurate sentence (e.g., four or five words out of ten words compared to a longer duration to produce nine out of ten words). This shows that the speaking rate for the inaccurate utterance is likely to be higher than the speaking rate for the accurate utterance. The team used speaking rate and speech initiation latency of accurate utterances only to control for this confound. In addition, the team targeted speaking rate because it affects persons with both fluent and nonfluent variants of aphasia.

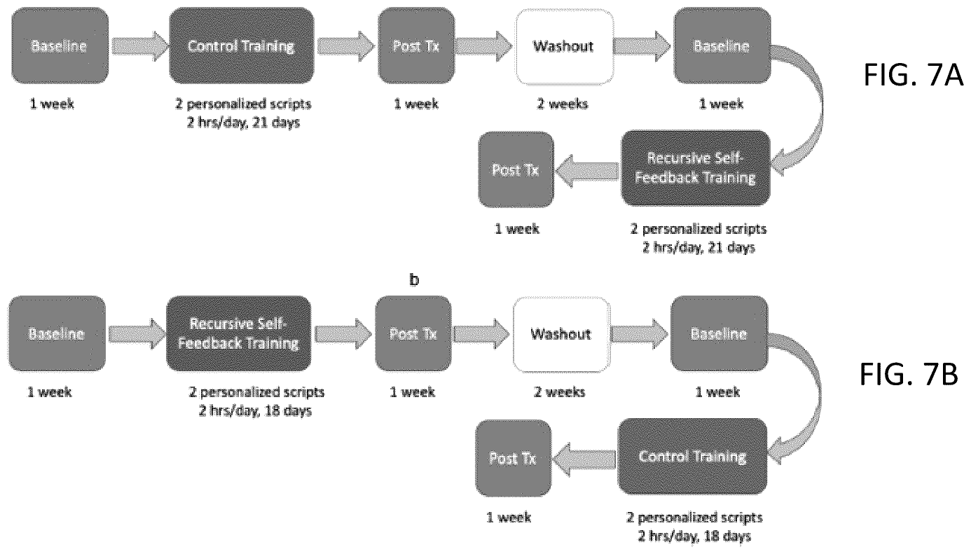

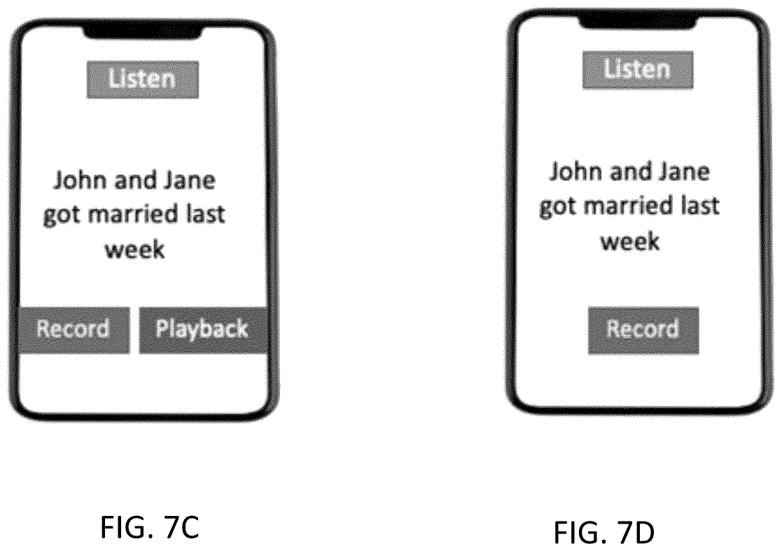

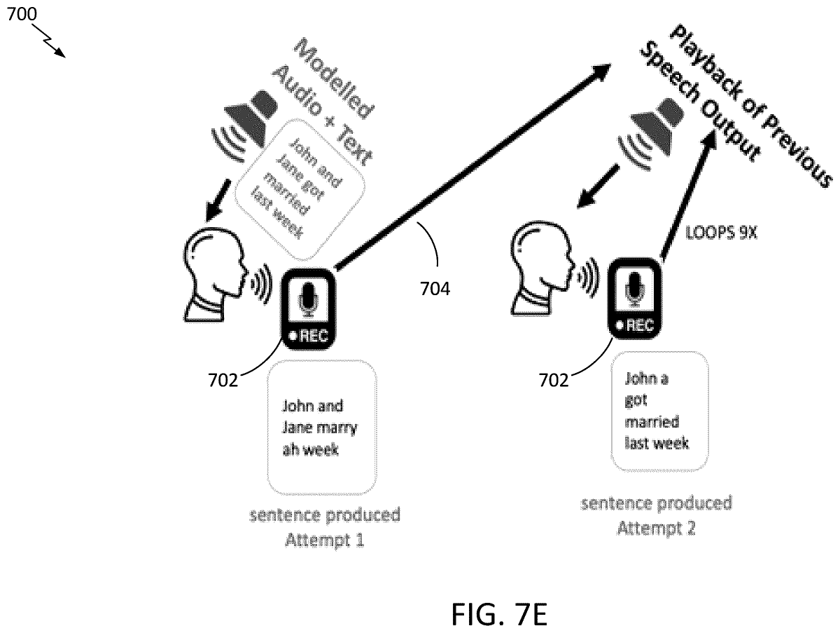

Study Design. The team used a cross-over single case experimental design, where each participant received two treatments sequentially. The treatments focused on script production; one with recursive self-feedback and a control training i.e., non-self-feedback script-based treatment. The control training approximates the standard script training but with no interaction and feedback from an SLP. The order of the treatments was counterbalanced across the two participants, as shown in the study protocol flow charts of FIG. 7A and FIG. 7B, respectively.

Participants The team recruited two adults (AE2: 6 years poststroke and AE3: 12 years poststroke), right-handed dominant speakers of American English, diagnosed with chronic nonfluent aphasia. Both participants met the following inclusion criteria: (i) mild-severe aphasia, secondary to a single stroke with relative ability to comprehend and comply with instructions during the screening interview and during treatment; (ii) premorbid dominant speakers of English as assessed by a language history self-report; (iii) no record of concomitant neurological disorders, such as dementia and neurodegenerative disorder (iv) normal or corrected to normal vision and hearing (v) no record of significant acquired neuromotor disorders; (vi) no more than minimal difficulty with pronunciation due to motor deficits (apraxia of speech). Both participants signed a written consent form after the team discussed the contents of the form with them. The consent form was approved by the Institutional Review Board of the City University of New York before commencing the experiment. The participants were recruited from Speech and Hearing Clinic at Lehman College, City University of New York in New York City.

Assessments The team used the Western Aphasia Battery Revised (WAB-R: Kertestz, 2007) to assess the type and severity of aphasia. The team used the Cognitive Linguistic Quick Test Plus (CLQT+: Helms Estabrooks, 2001) to screen for general cognitive deficits. The screening was done by an SLP with experience working with people with aphasia. Table 1 shows that AE2 had mild aphasia and AE3 had moderate aphasia. Both participants had relatively more difficulty with production tasks than comprehension tasks on the WAB and no significant cognitive impairments (Table 1). Through the aid of two SLPs, each participant completed a self-report, both reporting no concomitant neurological and uncorrected visual and hearing disorders.

TABLE 1
Demographics of initial study participants.

| | | | | | | CLQT+ Composite |
|---|---|---|---|---|---|---|
| | | | | | | Severity Score for |
| | | | | Language | | Aphasia |
| Participants | Gender | Age | Education | Spoken | WAB Measures | Administration |
| AE2 | Female | 50 | College | American | Fluency, grammatical | 39 (absence of |
| | | | (BS) | English* | competence and | nonlinguistic |
| | | | | Spanish | paraphasia: 6/10 | cognitive |
| | | | | | Spontaneous speech: | impairment) |
| | | | | | 14/20 | |
| | | | | | Auditory comprehension: | |
| | | | | | 9.85/10 | |
| | | | | | Speech repetition: 10/10 | |
| | | | | | Naming: 7.3/10 | |
| | | | | | Aphasia Quotient: 82.3 | |
| AE3 | Male | 53 | College | American | Fluency, grammatical | 35 (mild |
| | | | (MS) | English* | competence and | nonlinguistic |
| | | | | | paraphasia: 6/10 | cognitive |
| | | | | | Spontaneous speech: 13/20 | impairment) |
| | | | | | Auditory | |
| | | | | | comprehension: 9.33/10 | |
| | | | | | Speech repetition: 7.6/10 | |
| | | | | | Naming: 7.1/10 | |
| | | | | | Aphasia Quotient: 74.1 | |

Treatment The team used smartphone-based script treatments, administered through a mobile audio app the team developed and deployed using the Unity 2D development game engine (https://unity.com/). The app displays texts and delivers automated recursive speech playback of the participants' recorded speech and speech feedback from an external model (a prerecorded virtual speaker). The mobile app treatments allowed the team to administer treatment in an ecological setting outside the lab. The team used two treatments that involved production of sentences from personalized scripts. (1) Experimental treatment (recursive self-feedback training): participants produced sentences from a script using recursive self-feedback (see details below) vs. (2) Control treatment (control training): participants produced sentences from a script using a non-self-feedback protocol that included elements of script-based treatments, namely speech unison, feedback from an external proficient speaker, and repeated exposure to and production of scripts.

Scripts were personalized: the participants suggested a text or topic of interest to them (e.g., article on basketball). This was used to create two pairs of personalized scripts per participant and each unique pair was used for a specific treatment block. Each participant trained with four personalized scripts across the two treatment blocks. Each script was broken into eight sentences. The words in each sentence were frequently used words that are familiar to the participants. The team controlled for the length and complexity of the sentences per script which was determined by each participant's performance after repetition of practice sentences from a non-individualized practice script. The practice script was not used during the treatments or assessment of generalization of treatment effects. Afterwards, the sentences in the personalized scripts were converted to natural speech at a moderate rate using a text-to-speech software (fromtexttospeech.com). The speech and its corresponding text (i.e., sentence), were uploaded to the audio playback app with two versions, one for each of the experimental and control treatments.

The app fully automated the treatment sequence, switching between visual display of written sentences, audio playbacks and audio recording. A conceptual example of what a participant, patient or user would see in the user interface is depicted in FIG. 7C and FIG. 7D. As shown, the user interface contained buttons for “Listen”, “Record” and “Playback” in the initial study, though as described elsewhere it is contemplated that additional functionality and options are contemplated in mobile apps (e.g., including account information, scheduling and rescheduling of sessions, history and progress information, notifications and messages from a healthcare team, options for the user to input metadata, etc.). The app automatically switched between sentences across a script such that the participant does not need to keep track of the number of their repetition attempts. The “Listen” button played the prerecorded audio of the virtual speaker. The “Record” button activated the audio recording of the participants' speech at 44.1 kHz sampling rate during sentence repetition. Recording ended automatically after 16 seconds allotted for the production of each sentence within a script, and no speech sample per utterance could exceed this timeframe. The timeframe was determined by the participants' performance with the practice scripts. The recursive self-feedback version had just one additional “Playback” button (FIG. 7C) compared to the version for the control training (FIG. 7D).

In recursive self-feedback sessions, once the participants pressed the “Record” button (to record their first sentence repetition attempt), the “Listen” button is disabled, and script text was no longer shown. Without an external reference, the participant then repeated the sentence after listening to their previous performance. This was done recursively nine times, each time listening to the most recent repetition attempt. The participants performed ten iterations of each script sentence when the team add the first attempt, before self-feedback was provided, as shown in FIG. 7E.

The recursive process 700 depicted in FIG. 7E, was performed in part by having the software operating on the mobile app 702 record the user's speech and use that recorded speech as the ‘input’ 304 of the next step, such as done in a telephone game. In other words, for Attempt 1, the user was given a full/correct scripted sentence of “John and Jane got married last week,” and the participant/user spoke a sentence produced at Attempt 1. This sentence (however it was uttered by the participant/user) was then played back to the user as the ‘prompt’ for Attempt 2. (As described above, the user's spoken words from the previous Attempt can be presented back to the user in a variety of ways, such as through transcription or audio playback). This approach allowed user performance to drift in each iteration, until a new sentence was presented. The team instructed the participants to monitor and detect production errors in their previous performance and attempt to correct them in their subsequent performance across all iterations. Also, the team instructed the participants to begin speaking immediately after they heard a beep when they pressed the record button. The team instructed the participants to minimize delay across each iteration of script production. These processes were demonstrated through a practice app for recursive self-feedback training. Afterwards, the participants used the practice app to demonstrate their understanding of how to use the treatment app for recursive self-feedback training.

In further embodiments, the user's device (whether a mobile device or otherwise) not only records the user's audio but also records video of the user (e.g., the user's face, or video focusing on the user's mouth) as the user is speaking the given attempt. This audiovisual recording can then be played back to the user, so that the user can see their attempt (including mouth movements) as well as hear what they said. In other embodiments, to assist in training the user on spontaneous speech (rather than simply imitation or modeling of a scripted sentence), the user's device may present a question to the user that will elicit a verbal response. For example, the device may utilize a bank of common questions that can be responded to in an expected fashion, such as by reforming the question into a declarative statement that contains an answer: Question: “What is your favorite sport?” Answer: “Basketball is my favorite sport.” The question or prompt may be in the form of text, audio, or an audiovisual prompt. In other embodiments, the device may rely on an LLM to generate unique, novel questions to which the user must craft a response. The LLM can then infer what the user meant to say given the context of the question itself.

The non-self-feedback control treatment version of the app only played back the prerecorded speech, and it did not have the “Playback” button. Unlike the experimental version, the “Listen” button and displayed text were disabled only when the participants pressed the “Record” button to record each sentence repetition attempt. This means that these features were enabled after the duration allotted for each repetition attempt was timed out. In this treatment, each participant followed a protocol that approximated script training by including three key steps of script training. First, they read a sentence on the screen of their smartphones, and they listened to the prerecorded audio of the sentence. Secondly, they performed speech unison which involved repeating the sentence in tandem with the prerecorded virtual speaker. Lastly, they independently produce the sentence without support from the prerecorded speaker or written sentence. The participants performed these steps 10 times per sentence for all sentences in the script. The team provided the participants with similar instructions used during recursive self-feedback training except the one that pertained the use of their self-feedback for improving their performance. Here, too, they demonstrated their understanding of the protocol through a practice version of the control training.

Both treatments were administered through the participants' smartphones at the comfort of the participants' homes. AE2 received control training first which was followed by recursive self-feedback training. The team counterbalanced the order across the participants and AE3 first received the recursive self-feedback training, followed by the control training. The team checked in with the participants twice per week to remind them about the treatment procedure and for any bug in the app. The team performed in-person and remote check in before the COVID-19 pandemic, and remotely using Zoom during the pandemic. Each participant used both treatments for two hours per day, seven days a week for about three weeks. For each treatment block, the participants were required to train with the first and second personalized scripts for 8 to 11 days consecutively to accommodate a level of flexibility. There was a minimum of two weeks for washout between the two treatment blocks. The team determined treatment fidelity by requesting the participants to keep a diary of the days and times they practiced with the app. However, as discussed above, in further embodiments the application running on the users' mobile devices would automatically record and log such information, and manual recording would not be needed. In this study, the team were also able to obtain this information from the app which generated it automatically.

Assessment of Outcome Measures. The team calculated the outcome measures, speaking rate and speech initiation latency, from each participants' speech data during the administration of the treatments. The team analyzed speech data from all sessions. The team estimated direct treatment effects by comparing the participants' speech outcome measures on the first day of treatment with that on the last day of treatment. Generalization of treatment effects was tested through sentence repetition of new, non-personalized scripts. The length and complexity of each sentence was matched with what was used in the personalized scripts for the treatments. Each script included 16-18 sentences and each sentence was repeated five times. These were administered three times at each of four testing time: at the baseline phase and the posttreatment phases per treatment block. To estimate for generalization of treatment effects, the team administered to each participant the same non-personalized script in all assessment phases across both treatments. The baseline and posttreatment assessments of generalization of treatment effects were performed in-persons in the lab before the pandemic and remotely via Zoom during the pandemic.

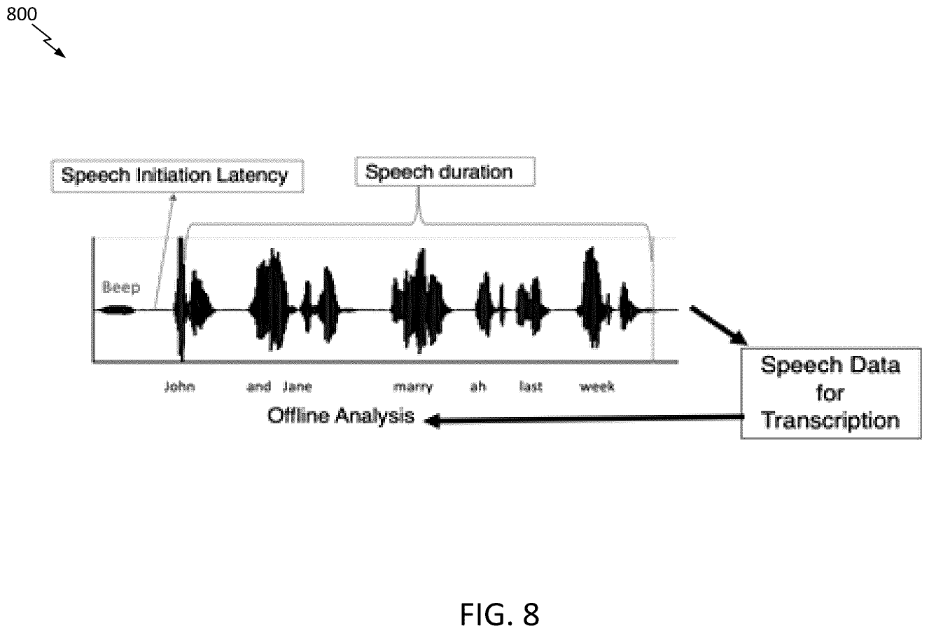

The team manually transcribed the speech data to text (though, of course, untrained or trained speech to text applications may also be used). All transcriptions were done by an SLP with experience analyzing language production of PWNA. The data used for estimating the direct and generalization of treatment effects were transcribed twice (blinded transcription) and inter-rater reliability assessments were done as well. The team derived the speech initiation latency and the speech duration from the speech samples through the Praat method, as depicted in FIG. 8. Speech initiation latency is the latency in milliseconds (ms) between the end of the beep sound and the start of the speech signal. The team did not include false starts as the beginning of a sentence. Speech duration (ms) is the time course of the speech signal including pauses, fillers, word errors and speech repetitions.

Speaking rate=Number of correct words produced×60/Speech duration (ms)

The team analyzed the transcribed utterances (i.e., sentences produced within a script) that were 90% accurate relative to the modelled sentence. About 97% of the total utterances (i.e., 7,492 out of 7,700) were accurate. No script trial was discarded. The team used a Python script to compute the speaking rate i.e., words per minute (wpm) through the derived speech duration and transcribed text data. To calculate speaking rate, the team divided the total number of correct words in a sentence by the speech duration, multiplied by 60. Correct words produced were words produced correctly in the correct order as represented in the original sentence and devoid of semantic errors and neologisms. Mild phonemic errors were ignored; for example, errors of phoneme omission, substitution, and addition (e.g., Setember [(/p/omitted)] for September). If there were repeated words or phrases, only the first word or phrase was considered correct. The team used the total duration of all utterances that met the 90% threshold to compute the speaking rate, which included the duration of word errors, fillers or repetitions that were excluded from determining correct words produced. The team performed an inter-rater reliability of transcribed correct words produced by determining the ratio of agreement between two independent raters on 10% of randomly selected speech samples used for estimating direct and generalization of treatment effects. A score approaching 100% implies a complete match between both raters scores. The inter-rater scores for both participants (AE2 and AE3) are described as follows: AE2 recursive self-feedback training: trained scripts (96%); AE2 control training: trained scripts (99%); AE2 recursive self-feedback training: untrained scripts (98%); AE2 control training: untrained scripts (97%); AE3 recursive self-feedback training: trained scripts (94%); AE3 control training: trained scripts (99%); AE3 recursive self-feedback training: untrained scripts (95%); and AE3 control training: untrained scripts (99%).

Descriptive Trend Analysis. The team performed a descriptive trend analysis using the slope-intercept form (y=mx+b) to examine the trend of improvement during the duration of both treatments. The team manually transcribed and analyzed speech samples from each participant's script repetition attempt for each session across both treatments. The team used systematic sampling to select speech samples from each participant's first completion of a trained-personalized script in each session over the duration of the two treatments.

The team analyzed 1,650 speech samples (per session: 79, SD: 3.53) from the duration of recursive self-feedback treatment and 1,472 speech samples (per session: 74, SD: 16.57) from the duration of the control training treatment for AE2. As for AE3, the team used 1,390 speech samples (per session: 77, SD: 3.32) from the duration of recursive self-feedback treatment and 1,244 speech samples (per session: 78, SD: 7.45) from the control training treatment. The team used speech samples from each participant's production of untrained scripts during the pre- and post-treatment phases to estimate the generalized treatment effects. Note, each participant did not practice with the untrained scripts during either treatment. The team used 398 and 471 speech samples from AE2's production of an untrained script during the control training and recursive self-feedback blocks respectively. As for AE3, the team used 534 and 333 speech samples from his production of the untrained script from the control training and recursive self-feedback blocks respectively. This makes a total of 7,492 speech samples, out of a total of 7700, that were analyzed in this study. Thus, only ˜3% of the data which are randomly distributed across both intervention phases were discarded.

A positive trend in speaking rate i.e., increase in speaking rate following each session of an treatment, means a gradual improvement in speaking rate over time. In contrast, a decrease in speaking rate following each session suggests worsening performance over time. A decline in the trend of latency i.e., speech initiation latency following each session suggests a gradual improvement in reducing effortfulness in producing speech. Whereas an increase in speech initiation latency as a function of the number of sessions suggests a gradual increase in effortfulness for the participants in producing speech.

Statistical Evaluation of Direct Treatment Effects. The team evaluated the overall direct treatment effects by using nonoverlap of all pairs (NAP) to compare each participant's speech outcome measures on the first day of each treatment block (the first day of the first trained script) with their outcome measures on the last day of the treatment block (the last day of the second trained script). The team computed the NAP effect size based on a 95% confidence interval and a p-value <0.05. The NAP effect size ranges between 0-1 where 0.5 is the null value due to matched overlap between both phases of assessment. The team used the following ranges of effect sizes to classify the degree of improvement. Weak effect: 0.5-0.65; moderate effect: 0.66-0.92; and strong effects: 0.93-1. The team used the ‘SingleCaseES’ package version 0.4.3 on R to compute the NAP effect size for the direct treatment effects per participant. The team computed the nonoverlap of all pairs effect size with a 95% confidence and a p-value lesser than 0.05.

Statistical Evaluation of Generalized Treatment Effects. The team estimated the generalized treatment effects by comparing each participants' performance on an untrained non-personalized script before the start of a treatment with their performance on the same script after each treatment. The team collected measures for estimating generalization of treatment effects three times per testing period during both treatment blocks. The generalized treatment effects of the treatments on speech initiation latency and speaking rate were estimated using NAP. The team used the same software package and applied the same parameters the team used for estimating the direct treatment effects.

Results. The team analyzed changes across sessions in speaking rate and speech initiation latency for the two participants with chronic aphasia when producing trained and untrained scripts, comparing recursive self-feedback training to control training. First, the team report trends for each participant and then the team report our findings for direct and generalized effects of the treatments per participant.

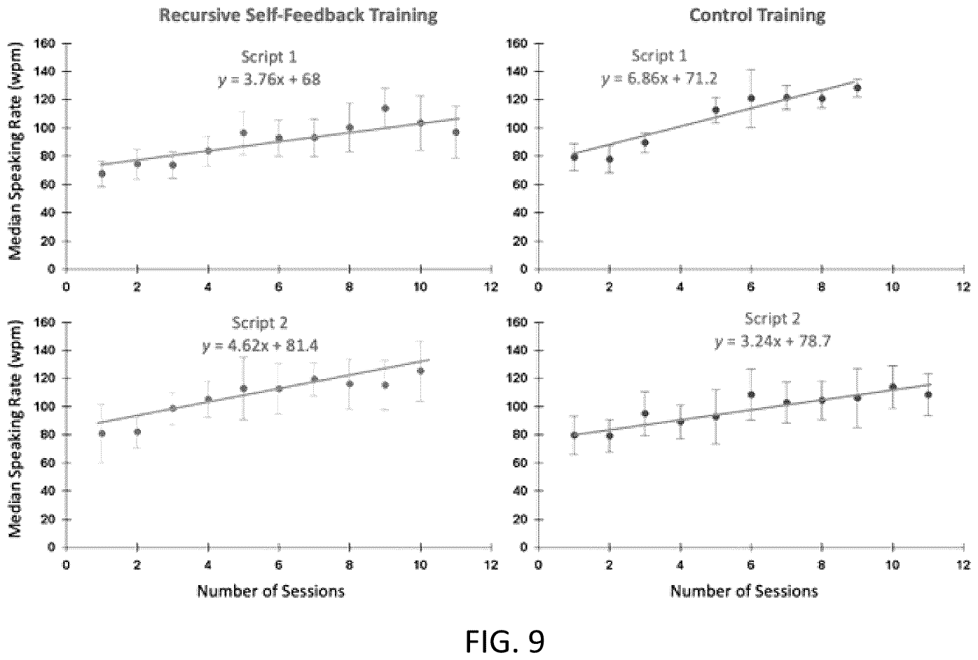

FIG. 9 is a set of graphs that shows the trend of participant AE2's speaking rate across all sessions of the two treatments. The figure shows a positive trend of speaking rate due to recursive self-feedback training in both script 1 (y=3.76x+68) and script 2 (y=4.62x+81.4). Similarly, the control training led to a positive slope in speaking rate in script 1 (y=6.86x+71.2) and script 2 (y=3.24x+78.7). These results suggest that AE2 improved her speaking rate over time across all the scripts during both recursive self-feedback training and the control training.

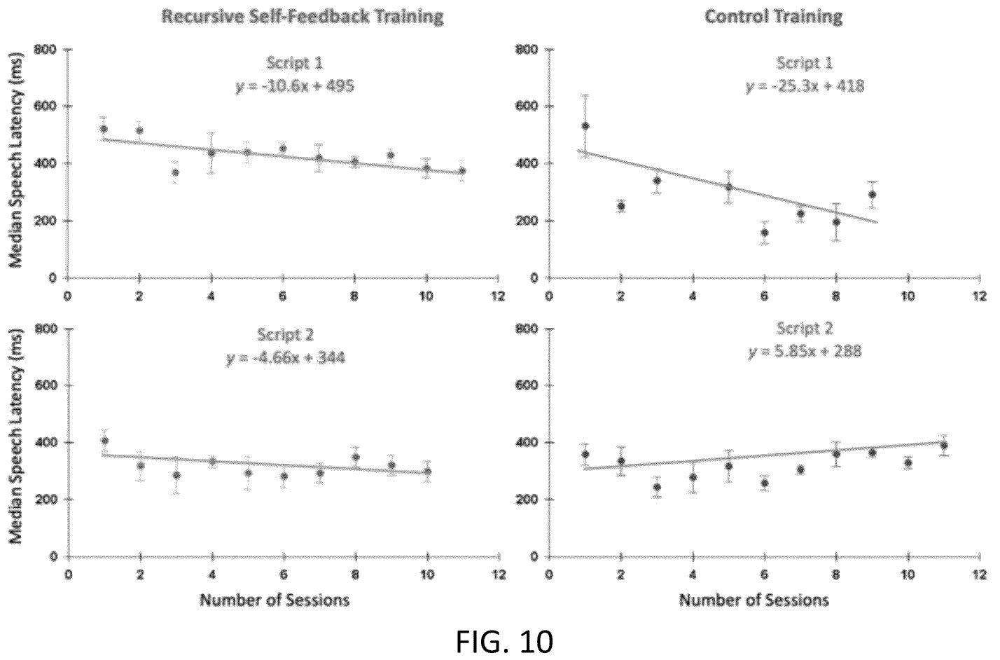

Speech initiation latency showed consistent negative trends in recursive self-feedback training in both script 1 (y=−10.6x+495) and script 2 (y=−4.66x+344). For control training, the trends were inconsistent i.e., y=−25.3x+418 for script 1 and y=5.85x+288 for script 2, as shown in FIG. 10.

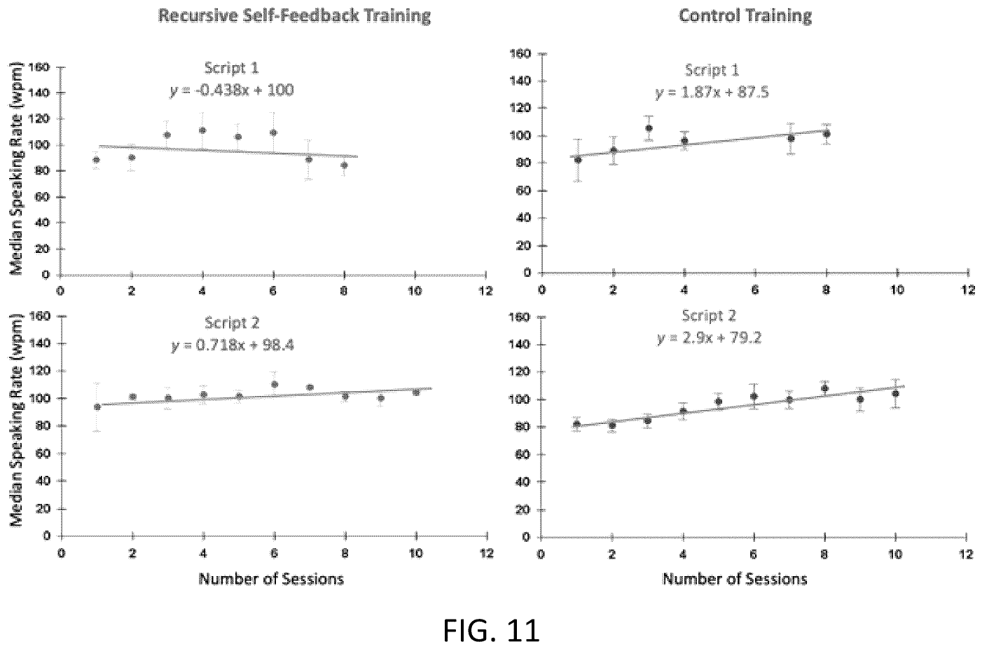

Participant AE3 showed inconsistent changes in speaking rate during recursive self-feedback sessions for script 1 (y=−0.438x+100) and script 2 (y=0.718x+98.4). However, control training improved speaking rate in both scripts i.e., y=1.87x+87.5 and y=2.9x+79.2 for scripts 1 and 2 respectively, as shown in FIG. 11.

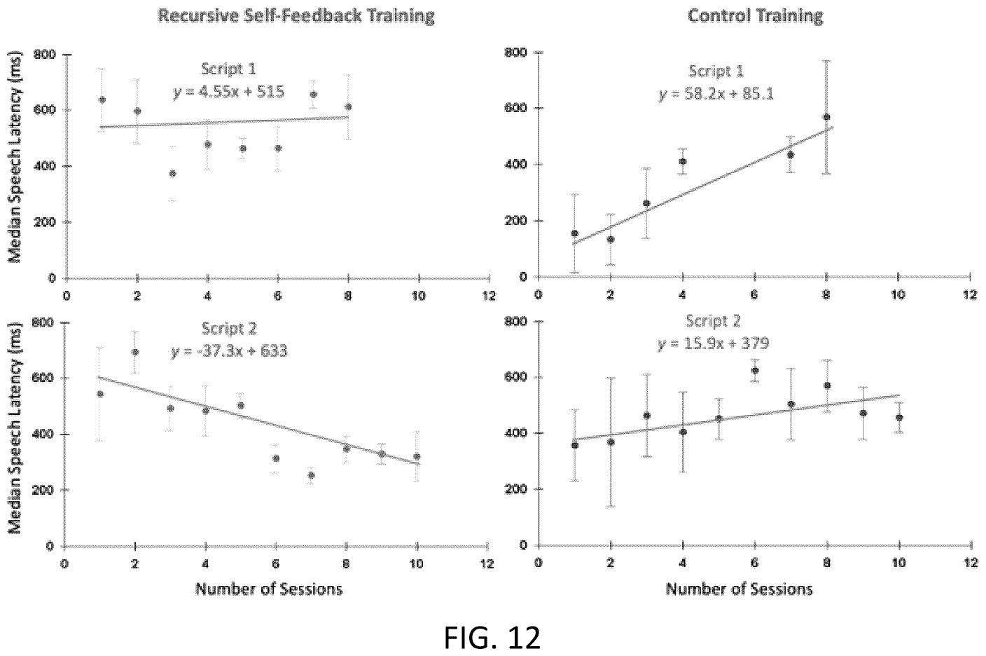

Finally, recursive self-feedback training led to inconsistent slopes in speech initiation latency (y=4.55x+515 and y=−37.3x+633), whereas in the control training the team observed a deterioration in speech initiation latency (y=58.2x+85 and y=15.9x+379) in participant AE3, as shown in FIG. 12.

Taken together, with recursive self-feedback, slopes show improvement in 6/8 measures, and similarly with the control training slopes show improvements in 6/8 measures, indicating an overall positive outcome in both treatments. The team next evaluated the effect size of each treatment based on these measures.

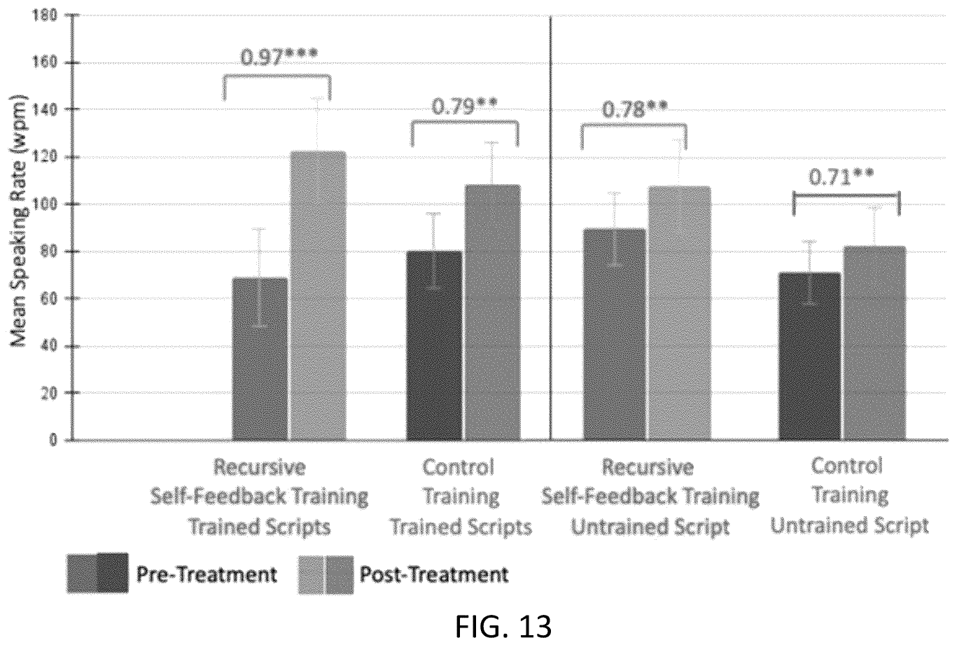

Effect Size of Both Treatments on the Primary Outcome Measures. The results show that AE2 improved her speaking rate following both recursive self-feedback training and control training i.e., non-self-feedback training (FIG. 13). For AE2, the nonoverlap of pairs effect size estimate (NAP) shows that recursive self-feedback resulted in a strong direct treatment effect (NAP=0.97, SE=0.01, p<0.05) on speaking rate while the control training resulted in a moderate direct treatment effect training (NAP=0.79, SE=0.05, p<0.05) on speaking rate. Similarly, recursive self-feedback training led to moderate improvement (NAP=0.78, SE=0.21, p<0.05) in speaking rate of untrained script while the control training improved speaking rate of untrained script moderately (NAP=0.71, SE=0.027, p<0.05). Note that in both cases, the effect size of recursive self-feedback training was slightly stronger than that of the control training.

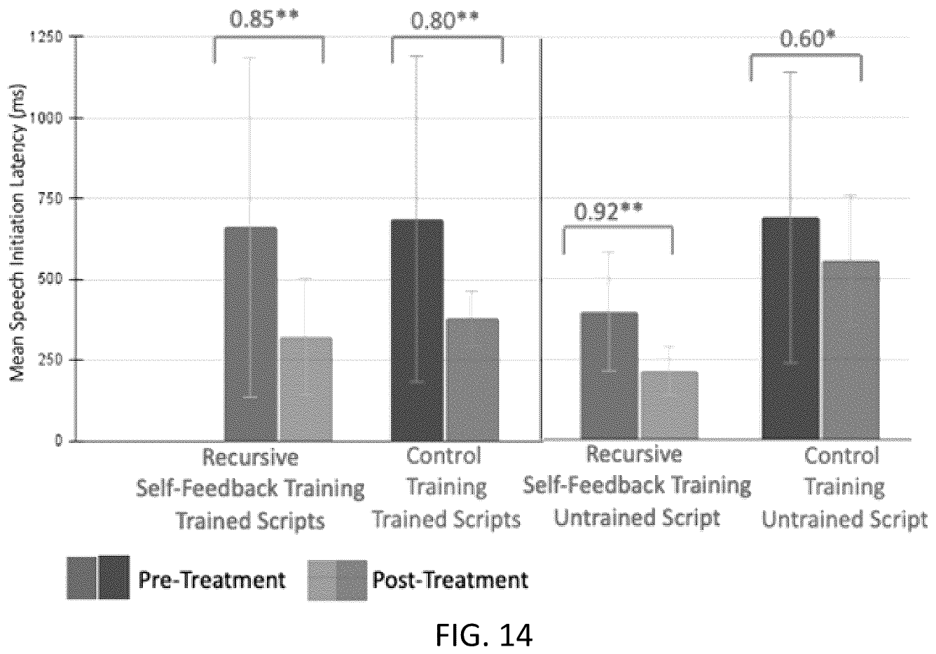

Participant AE2 improved her speech initiation latency in both the trained and untrained scripts after both treatments (FIG. 14). Specifically, recursive self-feedback training (NAP=0.85, SE=0.031, p<0.05) and the control training (NAP=0.80, SE=0.036, p<0.05) resulted in moderate improvement in speech initiation latency during repetition of trained scripts. There was strong improvement in speech initiation latency during repetition of untrained scripts following recursive self-feedback training (NAP=0.92, SE=0.14, p<0.05). Whereas the control training (NAP=0.60, SE=0.031, p<0.05) resulted in mild generalized effects on speech initiation latency to untrained scripts. Here too, in both cases, the effect size of recursive self-feedback training was slightly stronger than that of the control training.

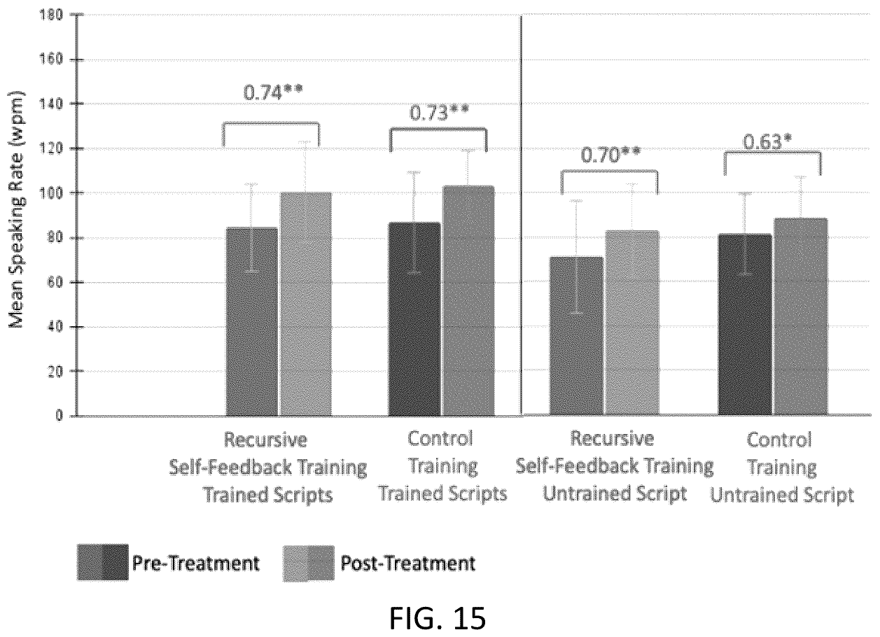

Participant AE3 improved his speaking rate (FIG. 15) in both the trained and untrained scripts following both recursive self-feedback training and the control training. For the trained scripts, recursive self-feedback training (NAP=0.74, SE=0.042, p<0.05) and the control training (NAP=0.73, SE=0.05, p<0.05) showed moderate effect sizes which suggest that AE3 benefitted from both treatments. Furthermore, FIG. 10 shows that recursive self-feedback training led to a moderate generalization of improvement (NAP=0.70, SE=0.029, p<0.05) in speaking rate following production of untrained scripts. Control training led to mild improvement in his speaking rate of producing sentences in the untrained script (NAP=0.63, SE=0.024, p<0.05). Overall, in both cases, the effect size of recursive self-feedback training was slightly better than the control training.

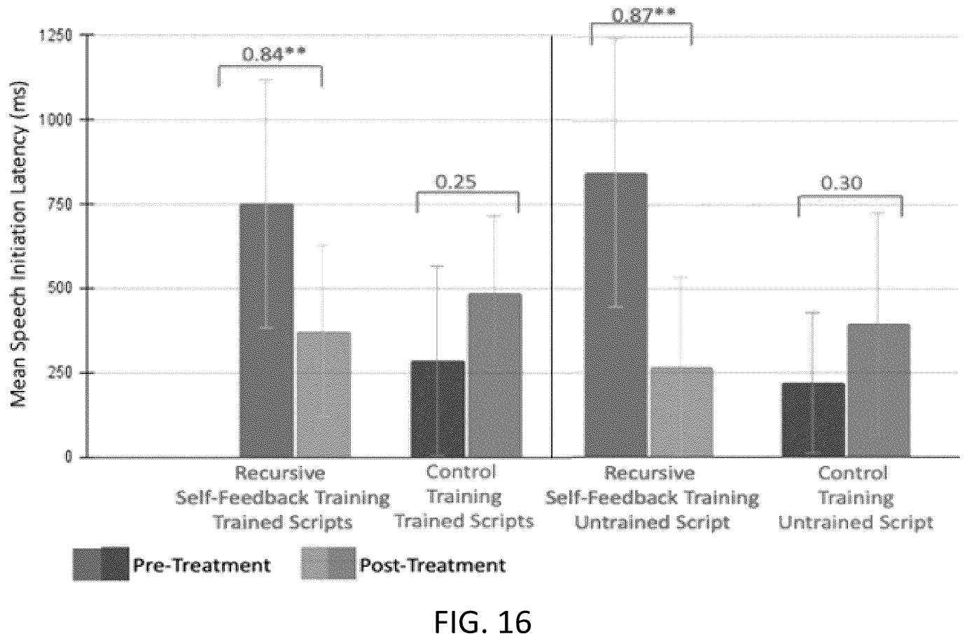

FIG. 16 shows that AE3 improved his speech initiation latency in both the trained and untrained scripts following recursive self-feedback training. However, he did not improve in this measure in both the trained and untrained scripts following the control training. Specifically, recursive self-feedback training led to improvements in speech initiation latency in the trained script (NAP=0.84, SE=0.033, p<0.05) and untrained script (NAP=0.87, SE=0.021, p<0.05). However, the control training did not improve speech initiation latency in the trained scripts (NAP=0.25, SE=0.05, p<0.05) and the untrained script (NAP=0.30, SE=0.023, p<0.05). Here, in both cases, the effect size of recursive self-feedback training was stronger than that of the control training.

Discussion The aforementioned study was an initial study for proof of principle to examine whether people with nonfluent aphasia (PWNA) can self-improve the fluency of their language production when producing scripts following treatment with recursive self-feedback. (As described below, several further studies validate and support these findings).

The team thus established that PWNA improved their fluency of language production when producing scripts following both protocols: recursive self-feedback training and non-self-feedback script-based treatment. PWNA have difficulties with language production, characterized by slow and effortful production, and impaired speech feedback mechanism for real-time monitoring and improvement of their language production. Recursive self-feedback provides PWNA the opportunity and sufficient time window to optimize and use only their self-feedback for improving their language production. The trend analysis showed that recursive self-feedback training and the control training largely resulted in improved speaking rate and speech initiation latency when producing scripts, which were maintained during the duration of the treatments. The team' findings on the effects of recursive self-feedback training supported that PWNA have a relatively preserved speech feedback system, which is compromised for real-time feedback, but which may be augmented by their preserved cognitive system and be useful for postproduction feedback.

The team' findings on the overall direct treatment effects of the two treatments show that both participants generally improved their speaking rate and speech initiation latency when producing scripts, but one participant (AE3) did not improve his speech initiation latency following the control training. That recursive self-feedback training induced improvement in speaking rate when producing scripts could be because recursive self-feedback provides a sufficient time window for the participants to monitor their prior production and improve their subsequent performance. Also, both treatments started with an externally modeled script production from a proficient (virtual) speaker which could have influenced positively the participants speech outcomes.

As well, these results show that script-based treatments may be beneficial for mitigating effortfulness in language production through a decrease in speech initiation latency. And, these findings suggest that PWNA can improve their language production during production of personalized trained scripts using only self-feedback. In part, their ability to improve their language production through our recursive self-feedback procedure stems from the increased time window for self-feedback during this procedure. This allowed PWNA more time to recruit cognitive non-linguistic processes such as self-monitoring and executive function for performance error detection and correction. These processes may compensate for their poor real-time production feedback system and facilitate their linguistic task performance, which shows that recursive self-feedback uses self-feedback loops to optimize recursively multiple subsystems (e.g., cognitive non-linguistic and linguistic subsystems) that PWNA engage to facilitate task performance. This learning mechanism is called recursive functional learning.

Improvements in speech initiation latency and speaking rate generalized to untrained scripts in both participants, although one participant (AE3) only improved his speaking rate, and not speech initiation latency, during production of an untrained script following the control training. Recursive self-feedback training provided opportunities for both participants to monitor and improve both speech outcome measures which was not emphasized in the control training. This could be a reason why participant AE3 did not improve his speech initiation latency in neither the trained nor untrained scripts after receiving the control training. In addition, these findings also showed that PWNA can improve the fluency of their language production without speech unison, a fluency-promoting condition which is an integral and active component of script-based treatments. Furthermore, recursive self-feedback induced improvements in PWNA script production despite not providing iterations of errorless, written scripts for imitation. Repeated exposure of errorless, written scripts is also an active ingredient of script-based treatments and was part of the control training. The team' findings show that speech unison and increased exposure to errorless written materials may be optional ingredients for script-based treatments for people with mild to moderate aphasia.

This study provided preliminary evidence on the sole use of self-feedback to improve speaking and speech initiation latency during production of scripts in two persons with moderate-mild chronic nonfluent aphasia. Recursive self-feedback isolates the unique role of self-feedback in facilitating aphasia recovery.

Following this initial study, the team performed similar studies that corroborated their findings, further establishing that the methods and systems described herein that employ recursive self-feedback techniques represent an improvement over externally-focused forms of speech therapy, due in part to a variety of novel aspects and benefits of the various embodiments described herein.

Impact of mHealth Approach on Speech Production. The team conducted a study to further evaluate RSF-based therapy versus external feedback-based therapy, in terms of their relative impact on improving speech production in PWNA. In this study, the team utilized an integrated mobile health (mHealth) approach, using two custom-developed mobile applications to guide participants through various types/durations of speech therapy remotely at their homes or other chosen locations outside of a clinic or therapy center. The study employed a crossover design, where participants underwent two sequential treatment blocks, one using RSF-based training and the other using external feedback-based training. Participants performed therapy sessions as dictated, guided, and delivered by the applicable mobile application, using mini tablets, over a period of 2-3 weeks per treatment type, with two-hour daily sessions. The study aimed to determine whether RSF-based therapy outperformed external feedback-based therapy in terms of improving a set of attributes of speech production that were measured by the mobile apps: speech fluency, speaking rate, and speech initiation latency, while also assessing how a mobile app could provide real-time insights into patients' usage, adherence, and preferences relative to the mobile app.

The custom mobile application played a crucial role in this study, with two distinct versions designed to deliver the RSF and external feedback conditions separately. The RSF app version allowed participants to record their own speech, play it back, and iteratively refine their production over multiple attempts. Each sentence from the scripted speech training was repeated eight times per prompt, with seven rounds of self-correction loops using automated playback to facilitate self-monitoring. The external feedback app version, in contrast, presented participants with a synthesized speech model using Wideo text-to-speech software, providing them with a correct version of the sentence after each attempt instead of self-generated playback. Both versions of the app were programmed to log usage data regarding the participants' efforts and results. In the study, the apps stored data that allowed the team to track the participants' engagement, frequency and duration of training sessions, timing of pauses between iterations, and overall compliance with the study protocol. This data enabled the team to monitor adherence remotely and analyze how different users approached RSF versus external feedback training. In other embodiments, however, it is contemplated that mobile apps that employ the methods and techniques described herein will record a variety of information regarding the participants' usage and therapy including: particular words, phrases, sentence structures, utterances, etc. that are misspoken frequently, pace of speech, volume of speech, tone of voice, and other information and statistics regarding the speech performance of the patient-user; full audio recordings of the user's speech, transcripts of the user's attempted and actual speech; performance metrics over time, such as error rate, time to complete sentences, pauses, etc.; metadata regarding the therapy sessions, such as geographic location, time of day, date, physiological information (such as blood pressure, heart rate, temperature, etc., including changes in these attributes during the therapy session), participant state of ‘stress’ versus ‘relaxation’, and the like. Moreover, the apps may be programmed to provide this information to a therapist, clinician, or other healthcare provider for review on an ongoing basis, and allow the healthcare team to remotely adjust settings for future therapy sessions, such as speech-specific criteria like sentence length and complexity, difficulty of words, frequency of words or phrases the patient is known to struggle with, frequency of various phonemes, etc.; session-specific criteria like spacing, timing, total daily duration, time of day, number, and duration of sessions; correction-related criteria, such as how many iterative attempts a patient is required to (or permitted to) undertake before moving on (either because a new script is provided or an external correction is given); recommendations for breaks or washout periods; etc.

The results of the study revealed that both feedback approaches improved participants' speech fluency, but RSF-based approaches unexpectedly demonstrated superior generalization effects, particularly in speaking rate and speech initiation latency. Participants using RSF-based therapy also exhibited more sustained improvements, with better carryover of learned-improved speech behaviors to new, previously-unattempted scripts, whereas those receiving external feedback-based therapy improved more quickly at first but showed less retention. The mobile app data further revealed that participants having undergone recent RSF-based therapy engaged in more varied, self-directed training behaviors, taking longer pauses between iterations and adjusting self-corrections dynamically. This suggests that the RSF approach allowed for deeper cognitive processing, leading to more durable speech improvements over time.

The team concluded that RSF outperformed external feedback because it encourages active self-monitoring, error detection, and iterative refinement. Unlike external feedback, which relies on external correction models, RSF places the burden of correction on the participant, fostering greater engagement, ownership, and awareness of their own speech errors. Additionally, the ability to pause, listen, and retry multiple times appears to have strengthened learning retention, enabling participants to develop greater autonomy in speech correction, as compared to external feedback approaches in which the full correction is given right away. Given the effectiveness of RSF-based speech training and the success of mobile health integration, the team determined that RSF-based therapies are amenable to full automation, such as via AI-assisted aphasia treatment programs, which can be deployed even without direct monitoring or prescribing by a healthcare professional, so as to improve accessibility for individuals who lack direct access to speech-language pathologists.

Impact on Sentence Production Efficiency. The team conducted a study of human subjects, to evaluate how recursive self-feedback (RSF)-based approaches compare to external feedback in terms of their relative influence on sentence production efficiency of patients with non-fluent aphasia (PWNA). Unlike previous studies that focused solely on feedback mechanisms, this research investigated how practice schedules (continuous vs. discontinuous practice) affect the benefits achievable with RSF vs external feedback, with an aim to determine how to optimize protocols and therapeutic training schedules to improve speech outcomes. The study aimed to determine whether allowing flexible, spaced practice schedules could enhance the effectiveness of RSF in comparison to traditional external feedback-based speech therapy.

Using a crossover study design, four PWNA participated in two treatment blocks-one with RSF and one with external feedback—where the treatment schedule varied between continuous (intensive) or discontinuous (spaced) practice schedules. RSF participants iteratively refined their speech by listening to and correcting their own previous productions, while external feedback participants received corrective speech models. The team measured the participants' speaking rate, which was analyzed to assess sentence production efficiency over time. Participants used a custom mobile application for speech practice at home, enabling automated tracking of practice schedules and speech production metrics.

This study's results demonstrated that RSF-based methods (such as disclosed herein) paired with a discontinuous (spaced) practice schedule resulted in more sustained long-term improvements as compared to external-based methods and/or RSF-based methods with continuous practice schedules. Based on review of these results, the team determined that a discontinuous/spaced practice schedule caused RSF participants to better consolidate what they were learning and optimize their own speech correction over time.

More specifically, the study examined how training schedule type influenced the effectiveness of recursive self-feedback (RSF)-based methods vs external feedback-based methods in speech therapy for PWNA. In the study, the team allowed the participants to choose between continuous (intensive) or discontinuous (spaced) practice schedules for each treatment block. (However, if is of course, contemplated that various systems and methods herein might instruct users to perform their training on specific spaced schedules, as described below, without necessarily giving the participants the option to self select a scheduling scheme). In the continuous practice schedule, participants were instructed to undergo their at-home training by completing a single two-hour session all at once, at one point during the day, so as to engage in uninterrupted training. In contrast, the discontinuous practice schedule allowed participants to distribute their two-hour practice across multiple sessions throughout the day, such as one hour in the morning and one hour in the evening, or four 30-minute sessions spread over different time periods. The team observed natural variability in how participants structured their spaced practice; while some maintained a consistent pattern of dividing their practice into two equal sessions per day, others varied their schedules day-to-day, opting for shorter or longer breaks between sessions based on personal preference. Regardless of the specific adherence by participants to a routine for the discontinuous therapy sessions, the study found that RSF-based programming was most effective when combined with discontinuous, spaced practice. In other words, instructing users, or at least encouraging or reminding them, to allow for meaningful breaks between therapy sessions results in enhanced learning retention, and also resulted in participants being able to invest more time in self-monitoring their speech improvements.

Accordingly, in some embodiments, a system or method may encourage users to spread out their training over the course of several sessions during the day. In some instances, this may entail prompting a user to select times of day at which the user would like to have a pop up notification or other reminder to begin a short training session, or resume an incomplete session. A suggested format may also be provided at this initial (or weekly/daily) set up phase, such as: two 1-hour trainings per day, in the morning and evening; or four half hour sessions, two in the morning and two in the evening; or other similar divisions. Such systems may also allow users to dynamically adjust their schedule on a day by day basis, such as through mobile device calendar integrations, a dedicated app, or the like.

Impact on Generalization/Improvement Transfer. The team also conducted another study to assess the generalization effects of the techniques and approaches described herein, including methods and systems that deploy recursive self-feedback (RSF) based therapy for individuals with aphasia. In this study, the team assessed how much RSF-based therapy could cause general improvements in connected speech production in individuals with chronic nonfluent aphasia. The study aimed to determine whether recursive self-feedback alone, without external guidance, could improve speech production and transfer those improvements to new speech tasks. The researchers compared RSF-based therapy to external feedback-based script training (which uses repeated providing of speech models generated by external sources).

To evaluate the effectiveness of RSF, the study employed a crossover design involving four individuals with chronic nonfluent aphasia. Participants underwent two different therapeutic phases: script production with recursive self-feedback and script production with external feedback. In the RSF therapy phase, participants listened to their own recorded speech and refined their production in multiple iterative attempts. In the external feedback condition, participants were instead provided with corrective speech models from an external source after each attempt. Both treatments were delivered remotely through mobile applications, allowing participants to practice independently at home. Each treatment lasted two to three weeks, with participants practicing for two hours per day, five days per week.

The results indicated that both treatments led to improvements in connected speech production, but RSF demonstrated superior enhancement in several microlinguistic measures. Participants showed greater gains in sentence completeness, grammatical accuracy, and speech informativeness after undergoing the RSF-based therapy protocol as compared to the external feedback-based therapy. While external feedback initially led to rapid improvements, RSF exhibited better generalization effects; for example, the participants transferred their learned speech skills more effectively to novel speech tasks beyond the trained scripts.

The results of this study demonstrate that RSF-based therapy outperformed external feedback-based therapy. The superior performance derives, at least in part, to certain aspects of the RSF-based therapy, such as its reliance on self-monitoring and iterative refinement. In other words, because the RSF-based therapy used in this study emphasized allowing individuals to take an active role in their own speech correction, RSF is able to encourage stronger cognitive engagement and long-term retention of speech improvements.

### Contemplated Embodiments

The techniques, technologies, algorithms, and advantages described herein may be implemented in a variety of practical applications, which may serve to improve systems and methods used or performed by several different individuals, companies, and/or institutions involved in speech therapy, mHealth, aphasia treatment, cognitive therapy, and the like.

In one category of embodiments, systems and methods may be configured to function as a tool to improve the ability of healthcare providers to give tailored care to their patients in a prompt and efficient manner. Thus, such embodiments may involve provider portals that allow providers to adjust settings, monitor progress and adherence, and ensure that routine treatment is available to their patients outside of the clinic, via mobile, adaptive, and effective delivery approaches. These embodiments may include enriched features for allowing providers and patients to communicate and coordinate the delivery of speech therapy on an ongoing basis, such as private messaging, posting results and feedback, and coordinating adjustments to settings and analysis of trends and outliers.

Alternatively, or additionally, the systems and methods describe above may be embodied in a more user-driven implementation, that relies on automated logic and/or an AI agent to suggest prescription settings and updates based on user capability and progress. Thus, in such embodiments, a provider portal may not necessarily be utilized, and instead settings, feedback, and overall management and guidance of therapy may be performed according to prewritten logic. For example, as a user develops a given proficiency, the system automatically increases difficulty. Or, as the system detects a user struggling with given phonemes or sentence constructs, a LLM may be utilized to give variations of those troublesome aspects via new scripts that correlate with personal interests.

In the foregoing specification, implementations of the disclosure have been described with reference to specific example implementations thereof. It will be evident that various modifications may be made thereto without departing from the broader spirit and scope of implementations of the disclosures as set forth in the following claims. The specification and drawings are, accordingly, to be regarding in an illustrative sense rather than a restrictive sense.

What is claimed is:

1. A method, comprising:
receiving a speech response of a subject to a prompt;
comparing the speech response to a previous speech response of the subject;
determining a complexity for a subsequent prompt based on the comparison;
applying a language model to the speech response to generate a corrected speech response;
generating the subsequent prompt based on the determined complexity and the corrected speech response; and
providing the subsequent prompt to the subject to receive a subsequent speech response.

2. The method of claim 1, further comprising:
receiving an initial speech response to the prompt;
applying a speech-to-text model to generate an initial speech response transcription;
applying the first or a second language model to generate a corrected initial speech response transcription;
applying a text-to-speech model to the corrected initial speech response transcription to generate a corrected initial speech response;
providing the corrected initial speech response to the subject; and
receiving the speech response in response to providing the corrected initial speech response to the subject.

3. The method of claim 2, wherein the corrected initial speech response is generated as a voice imitation of the subject.

4. The method of claim 1, further comprising:
receiving an initial speech response to the prompt;
providing the initial speech response to the subject; and
receiving the speech response from the subject responsive to providing the initial speech response to the subject.

5. The method of claim 4, further comprising:
receiving an audiovisual recording comprising the initial speech response; and
providing the initial speech response by outputting the audiovisual recording.

6. The method of claim 1, wherein comparing the speech response to the previous speech response comprises comparing acoustic measurements of the speech response and the previous speech response.

7. The method of claim 1, wherein comparing the speech response to the previous speech response comprises comparing linguistic measurements of the speech response and the previous speech response.

8. The method of claim 1, wherein the subsequent prompt comprises the corrected speech response.

9. The method of claim 1, wherein comparing the speech response to the previous speech response comprises comparing the speech response to a learning curve determined using the previous speech response.

10. A non-transitory computer readable medium storing computer-executable instructions to:
receive a speech response of a subject to a prompt;
compare the speech response to a previous speech response of the subject;
determine a complexity for a subsequent prompt based on the comparison;
apply a language model to the speech response to generate a corrected speech response;
generate the subsequent prompt based on the determined complexity and the corrected speech response; and
output the subsequent prompt.

11. The non-transitory computer readable medium of claim 10, storing further computer-executable instructions to:
receive an initial speech response to the prompt;
apply a speech-to-text model to generate an initial speech response transcription;
apply the first or a second language model to generate a corrected initial speech response transcription;
apply a text-to-speech model to the corrected initial speech response transcription to generate a corrected initial speech response;
output the corrected initial speech response; and
receive the speech response in response to outputting the corrected initial speech response.

12. The non-transitory computer readable medium of claim 11, wherein the computer-executable instructions are to generate the corrected initial speech response as a voice imitation of the subject.

13. The non-transitory computer readable medium of claim 10, storing further computer-executable instructions to:
record an initial speech response to the prompt;
output the initial speech response to the subject; and
record the speech response following outputting the initial speech response to the subject.

14. The non-transitory computer readable medium of claim 13, storing further computer-executable instructions to:
receive an audiovisual recording comprising the initial speech response; and
provide the initial speech response by outputting the audiovisual recording.

15. The non-transitory computer readable medium of claim 10, wherein the computer-executable instructions to compare the speech response to the previous speech response comprise computer-executable instructions to compare acoustic measurements of the speech response and the previous speech response.

16. The non-transitory computer readable medium of claim 10, wherein the computer-executable instructions to compare the speech response to the previous speech response comprise computer-executable instructions to compare linguistic measurements of the speech response and the previous speech response.

17. The non-transitory computer readable medium of claim 10, wherein the computer-executable instructions to compare the speech response to the previous speech response comprise computer-executable instructions to compare the speech response to a learning curve determined using the previous speech response.
